(19) United States
(12) Patent Application Publication
(10) Pub. No.: US 2016/0239831 A1
(43) Pub. Date: Aug. 18, 2016

(54) NETWORK BASED MONEY AND VALUE TRANSFER SERVICE WITH A DIGITAL WALLET

(71) Applicant: DOMUS SEMO SANCUS, Providenciales (TC)

(72) Inventor: Erwin Jay SAUNDERS, Blue Mountain (TC)

(21) Appl. No.: 15/046,233

(22) Filed: Feb. 17, 2016

Related U.S. Application Data
(60) Provisional application No. 62/117,400, filed on Feb. 17, 2015.

(51) Int. Cl. G06Q 20/36; G06Q 20/40; G06Q 20/10

(52) U.S. Cl. CPC G06Q 20/36; G06Q 20/10; G06Q 20/405; G06Q 20/4016

(57) ABSTRACT

Disclosed is an Internet Based Money or Value Transfer Service with a digital wallet. A method to reduce the risk of any transaction being used for money laundering and terrorist financing purposes. Associating a digital wallet user with the user's verified personal information information and biometric information, using a processor and a memory and limiting the requested financial transaction amount by a digital wallet user, Transaction Risk Score, and/or the digital wallet user's risk score, and/or country rating, such as the Basel AML Index scores of the countries in the primary addresses of the selected beneficiary and the digital wallet user. A maximum withdrawal amount is imposed on a digital wallet user per the period. It automatically determines the transaction risk score in real time by analyzing the digital wallet user's risk score and verified personal information and permits any authorized payout center to bid on and fulfill a money services request by the digital wallet user.

### PRIORITY CLAIM

This application claims priority of U.S. Provisional Application Ser. No. 62/117,400, filed Feb. 17, 2015, the entire disclosure of which is incorporated herein by reference.

### FIELD OF TECHNOLOGY

This disclosure relates generally to money or value transfer services. More particularly, an internet based money or value transfer service with a digital wallet is provided that includes features to reduce the risk of any transaction being used for nefarious purposes.

### BACKGROUND

Money or value transfer services may be the transfer of money or an item of value by an initiator of the transaction (e.g. a remittance sender) to a beneficiary of the transaction (e.g., a remittee). Money or value transfer services (MVTS) refers to financial services that involve the acceptance of cash, cheques, other monetary instruments or other stores of value and the payment of a corresponding sum in cash or other form to a beneficiary by means of a communication, message, transfer, or through a clearing network. Transactions performed by such services can involve one or more intermediaries and a final payment to a third party, and may include any new payment methods.

Unfortunately, due to the perceived risks—e.g. money laundering, terrorist financing, etc.—associated with money services, many companies (e.g., banks) are refusing (a process known as de-risking) to provide services to money or value transfer services businesses—especially money or value transfer services businesses that provide remittance services.

As a result, those companies that do offer services to money or value transfer services businesses are significantly increasing the cost of such services. Money or value transfer services businesses may face difficulties in determining which customers are to be trusted, and which transactions are benign and which are being used for nefarious purposes. In addition, many money or value transfer services businesses may not—or cannot—offer services over each other's networks (e.g. Western Union®-to-MoneyGram®-to-beneficiary), which results in a duplication of resources, and ultimately higher cost to the end consumer. For this reason, money or value transfer services businesses may be limited in their ability to provide affordable money services consumers, while adequately managing the risk that their services are being not used for illegal purposes.

### SUMMARY

This disclosure relates generally to money or value transfer services, and systems and method for providing such a service. More particularly, an internet based money or value transfer service with a digital wallet is provided with features to generally reduce the risk of any transaction being used for nefarious purposes.

In one aspect, an example method of the internet based money or value transfer service server includes associating a digital wallet user with the user's verified personal information, e.g., verified personal information such as Know Your Customer (KYC) information (based on the Financial Action Task Force (“FATF”) requirements) plus his/her biometric information, using a processor and a memory. The method may also include limiting a financial transaction by a digital wallet user per:
a period, and/or
the Transaction Risk Score,
and/or the digital wallet user's risk score, and/or
(if applicable) the risk score of the selected beneficiary of the transaction,
and/or a rating of the the countries in the primary addresses of the selected beneficiary and the digital wallet user, e.g., their most recent Basel AML Index score.
   The number of unique financial transactions by a digital wallet user may also be constrained per:
the period, and/or the
Transaction Risk Score, and/or
the digital wallet user's risk score.
   In addition, the number of Active Beneficiaries—e.g. remittees—by a digital wallet user may be limited per:
the risk score of the digital wallet user.
   A potential beneficiary maybe restricted/rejected based on:
his/her/its primary addresses, or
his/her/its risk score, or
whether he/she/it is on a restricted list,
a rating of the countries listed in the primary addresses, e.g., their most recent Basel AML Index score, or
if the countries listed in the primary addresses are on any type of restricted list.
   Also, the method limits the wallet balance of a digital wallet user per:
the period, or
the digital wallet user's risk score.
   The deposit amount (also referred to as a “Cashing In” amount) to a digital wallet is also limited:
per the period, and/or
the Transaction Risk Score, and/or
the digital wallet user's risk score, and/or
the location where the transaction is taking place, and/or
the risk score of the depositor if he/she/it is not the digital wallet user.
   A withdrawal amount may also be referred to as a “Cashing Out” amount. Further, a maximum withdrawal amount may be imposed on a digital wallet user per:
the period, or
based on a risk determination, e.g., the Transaction Risk Score, or the digital wallet user's risk score.
   The User Risk Score is determined by the method in real time by analyzing the:
user's verified personal information, e.g., KYC (Know Your Customer) information (based on the Financial Action Task Force requirements),
the user's biometric information (at least one of a fingerprint, a voice print, and/or an iris scan),
the user's social media profile,
(if applicable) the risk scores of the user's beneficiaries,
the country of birth of the user,
whether the user is on a restricted list (e.g., a sanctioned list, watch list, wanted list, or person in public life list),
meta-data, and/or
a background check factor,
and/or the country listed in the primary address of the user, whereby the country's rating, e.g., its most recent Basel AML Index score, is checked, as well as to see if it is on any type of restricted list.
   In addition, the method automatically determines the Transaction Risk Score in real time by analyzing:
the digital wallet user's risk score and KYC information, and/or
(if applicable) the risk score of the selected beneficiary,
the starting and ending locations of the transaction (e.g., the physical and/or network address locations of the digital wallet user and the selected beneficiary),
the time and date of the transaction,
checking the country of birth of the digital wallet user and if the digital wallet user and (if applicable) the selected beneficiary are on a restricted list,
meta-data,
a background check factor,
and/or the most recent Basel AML Index scores of the countries listed in the primary addresses of both the digital wallet user and the selected beneficiary, and if they any of them are on any type of restricted lists, and/or
(if necessary) the method and format in which the funds or items of value are to be received.
   The method also permits any authorized Payout Center to bid on and fulfill a money services request by a digital wallet user based on:
the Transaction Risk Score, and/or
an optimization of the request by the digital wallet user, and
(if applicable) the selected beneficiary, and/or
the locations of the selected beneficiary and/or the digital wallet user—provided that the locations of the selected beneficiary and/or the digital wallet user are not considered a risk by the internet based money or value transfer service server,
   and have the required KYC information of the digital wallet user and (if applicable) the selected beneficiary automatically sent to the payout center by the internet based money or value transfer service server, and once the transaction is fulfilled allow the payout center to automatically provide the Internet Based Money or Value Transfer Service server with the transaction details which may be forwarded onto the digital wallet user and/or the selected beneficiary.

A regulator, a banking partner, and/or a required third party may be provided a view access to the internet based money or value transfer service system. The meta-data may be gathered through public and/or private sources (e.g. a government directory, user provided KYC information, a social media profile, and/or a customer database). A regulator, a banking partner, and/or a required third party may be provided reporting access to the internet based money or value transfer service system.

All digital wallet users may be required to sign up—including (if required) pre-enrolling their beneficiaries—at an authorized center where their personal and biometric details will be captured prior to being permitted to use the internet based money or value transfer service system.

An account may be provided when a customer care agent of an authorized center creates an account for a digital wallet user-including (if required) pre-enrolling the user's beneficiaries. Further, the method may include assessing employees of the authorized centers and the digital wallet users (and if applicable, their beneficiaries) for risk, and based on the assessment automatically generate their User Risk Scores and keep the same updated in real-time based on any changes in the data in which the assessment was based. The method may determine (e.g. using authorization module) if the employees of the authorized centers and the digital wallet users (and if applicable, their beneficiaries) are on a restricted list, and if the countries listed in the primary addresses of the employees of the authorized centers and the digital wallet users and (if applicable) their beneficiaries are considered a risk by FATF, or the Basel Institute, and/or if they are on any type of restricted list. The employees of the authorized centers and the digital wallet users (and if applicable, their beneficiaries) may be verified (e.g. using verification module) through the provided KYC information—including multiple Government ID's, proof of the provided primary addresses, biometric information, etc.

The method of the internet based money or value transfer service server may include verifying (e.g. using verification module) the primary addresses of the employees of the authorized centers and the digital wallet users (and if applicable, their beneficiaries) using a processor and the memory. Biometric information of the employees of the authorized centers and the digital wallet users (and if applicable, their beneficiaries) may be captured and validated (e.g. using verification module). The biometric information may be a fingerprint, a voice print, and/or an iris scan. The countries of birth of the employees of the authorized centers and the digital wallet users (and if required, their beneficiaries) may be verified (e.g. using verification module) and accessed for risk based on the country's most recent Basel AML Index score and/or if they are on any type of restricted list, using the processor and the memory.

The risk score of a user (“User Risk Score”) may based on on all or a subset of:
his/her/its KYC information,
the user's biometric information (at least one of a fingerprint, a voice print, and/or an iris scan),
the user's social media profile,
(if applicable) the risk scores of his/her/its beneficiaries,
the country of birth of the user,
whether the user is on a restricted list,
meta-data, and/or
a background check factor, and/or
the country listed in the primary address of the user, whereby the country's rating, e.g., its most recent Basel AML Index scores, is checked, as well as to see if it is on any type of restricted list.

The risk score of a transaction (“Transaction Risk Score) may be based on all or a subset of:
the digital wallet user's risk score and KYC information, and/or
(if applicable) the risk score of the selected beneficiary,
the starting and ending locations of the transaction (e.g., the physical and/or network locations of the digital wallet user and the selected beneficiary),
the time and date of the transaction,
checking the country of birth of the digital wallet user and if the digital wallet user and (if applicable) the selected beneficiary are on a restricted list,
meta-data, or
a background check factor, and/or
the countries listed in the primary addresses of both the digital wallet user and the selected
beneficiary whereby the countries' most recent Basel AML Index scores are checked, as well as to see if any of them are on any type of restricted list, and/or
(if necessary) the method and format in which the funds or items of value are to be received.

The internet based money or value transfer service system is accessible from an internet based device with an “active” data connection over an internet protocol (IP) based network infrastructure. A short message may be sent to a digital wallet user and (if applicable) the selected beneficiary confirming the transaction, including:
the time and/or the location of the transaction,
the transaction amount,
the digital wallet user's account balance,
and/or a set of details of the receipt of funds of the transaction.
   The risk score of a digital wallet user may be adjusted if the digital wallet user provides additional verified personal information, such as KYC or other personal information. An option may be provided to allow a digital wallet user to select from a list of authorized Payout Centers, r.g. remittance vendors—to complete a transaction request or to conduct a direct wallet-to-wallet transaction from one digital wallet user to another digital wallet user.

In one aspect, the method of the internet based money or value transfer service server includes associating a digital wallet user with the user's verified personal information, such as KYC information (based on the Financial Action Task Force requirements) and his/her biometric information, using a processor and a memory. The method also includes limiting any financial transaction amount by a digital wallet user per:
a period, and/or
the Transaction Risk Score, and/or
the digital wallet user's risk score, and/or
(if applicable) the risk score of the selected beneficiary of the transaction, and/or
the most recent Basel AML Index scores of the countries in the primary addresses of the selected beneficiary and the digital wallet user.
   The number of unique financial transactions by a digital wallet user may also be constrained per:
the period, and/or
the Transaction Risk Score, and/or
the digital wallet user's risk score.
   In addition, the number of Active Beneficiaries—e.g. remittees—by a digital wallet user may be limited per:
the risk score of the digital wallet user.
   A potential beneficiary maybe restricted/rejected based on:
his/her/its primary addresses,
his/her/its risk scores,
whether he/she/it is on a restricted list, and/or
the most recent Basel AML Index scores of the countries listed in the primary addresses, and/or
if the countries listed in the primary addresses are on any type of restricted list.
   Also, the method limits the wallet balance of a digital wallet user per:
the period, and/or
the digital wallet user's risk score.
   The deposit amount to a digital wallet may also be limited per:
the period, and/or
the Transaction Risk Score and/or
the digital wallet user's risk score, and/or
the location where the transaction is taking place, and/or
the risk score of the depositor if he/she/it is not the digital wallet user.
   Further, a maximum withdrawal amount is imposed on a digital wallet user per:
the period, and/or
the Transaction Risk Score, and/or
the digital wallet user's risk score.
   The method automatically determines the User Risk Score in real time by analyzing:
the user's KYC information,
the user's biometric information (at least one of a fingerprint, a voice print, and/or an iris scan),
the user's social media profile,
(if applicable) the risk scores of the user's beneficiaries,
the country of birth of the user,
whether the user is on a restricted list,
meta-data, and/or
a background check factor, and/or
the country listed in the primary address of the user, whereby the country's most recent Basel AML Index score is checked, as well as to see if it is on any type of restricted list.

In addition, the method automatically determines the Transaction Risk Score in real time by:
analyzing the digital wallet user's risk score and KYC information, and/or
(if applicable) the risk score of the selected beneficiary,
the starting and ending locations of the transaction (e.g., the physical and/or network locations of the digital wallet user and the selected beneficiary),
the time and date of the transaction,
checking the country of birth of the digital wallet user, and
if the digital wallet user and (if applicable) the selected beneficiary are on a restricted list,
meta-data, and/or
a background check factor, and/or
the countries listed in the primary addresses of both the digital wallet user and the selected beneficiary whereby the countries' ratings, e.g., their most recent Basel AML Index scores, are checked, as well as to see if they are on any type of restricted list, and/or
(if necessary) the method and format in which the funds or items of value are to be received.
   The method also permits any authorized Payout Center to bid on and fulfill a money services request by a digital wallet user based on:
the Transaction Risk Score, and/or
an optimization of the request by the digital wallet user, and
(if applicable) the selected beneficiary, and/or
the locations of the selected beneficiary and/or the digital wallet user—provided that the locations of the selected beneficiary and/or the digital wallet user are not considered a risk by the internet based money or value transfer service server,
   and have the required KYC information of the digital wallet user and (if applicable) the selected beneficiary automatically sent to the payout center by the Internet Based Money or Value Transfer Service server, and once the transaction is fulfilled allow the payout center to automatically provide the internet based money or value transfer service server with the transaction details which may be forwarded onto the digital wallet user and/or the selected beneficiary. In addition, the method assesses employees of the authorized centers and the digital wallet users (and if applicable, their beneficiaries) for risk, and based on the assessment automatically generate their User Risk Scores and keep the same updated in real-time based on any changes in the data in which the assessment was based.

The method may determine (e.g. using authorization module) if the employees of the authorized centers and the digital wallet users (and if applicable, their beneficiaries) are on a restricted list, and if the countries listed in the primary addresses of the employees of the authorized centers and the digital wallet users and (if applicable) their beneficiaries are considered a risk by a rating orgnization, such as the FATF, or the Basel Institute, and/or if they are on any type of restricted list. Further, the method includes verifying (e.g. using verification module) the employees of the authorized centers and the digital wallet users (and if applicable, their beneficiaries) through the provided KYC information—including multiple Government ID's, proof of the primary addresses, biometric information, etc. The method also includes verifying (e.g. using verification module) the primary addresses of the employees of the authorized centers and the digital wallet users (and if applicable, their beneficiaries) using a processor and the memory.

The method of the internet based money or value transfer service server includes capturing and validating biometric information of the employees of the authorized centers, the digital wallet users, (and if required, their beneficiaries). The biometric information may be a fingerprint, a voice print, and/or an iris scan. The method also includes verifying (e.g. using verification module) and assessing for risk (based on the country's most recent Basel AML Index score) the countries of birth of the employees of the authorized centers and the digital wallet users (and if applicable, their beneficiaries) based on the countries' most recent Basel AML Index scores and/or if they are on any type of restricted list, using the processor and the memory.

In yet another aspect, an example method of the internet based money or value transfer service server includes associating a digital wallet user with the user's KYC information (based on the Financial Action Task Force requirements) and his/her biometric information, using a processor and a memory. The method also includes limiting any financial transaction amount by a digital wallet user per:
a period, and/or
the Transaction Risk Score, and/or
the digital wallet user's risk score, and/or
(if applicable) the risk score of the selected beneficiary of the transaction, and/or
the most recent Basel AML Index scores of the countries in the primary addresses of the selected beneficiary and the digital wallet user.
   The number of unique financial transactions by a digital wallet user may also be constrained per:
the period, and/or
the #TransactionRiskScore, and/or
the digital wallet user's risk score.
   In addition, the number of Active Beneficiaries—e.g. remittees—by a digital wallet user may be limited per:
the risk score of the digital wallet user.
   Also, the method limits the wallet balance of a digital wallet user per:
the period, and/or
the digital wallet user's risk score.
   The deposit amount to a digital wallet may also be limited per:
the period, and/or
based on the Transaction Risk Score, and/or
the digital wallet user's risk score, and/or
the location where the transaction is taking place, and/or
the risk score of the depositor if he/she/it is not the digital wallet user.
   Further, a maximum withdrawal amount may be imposed on a digital wallet user per:
the period, and/or
the Transaction Risk Score, and/or
the digital wallet user's risk score.
   The method of the internet based money or value transfer service server includes automatically determining the Transaction Risk Score in real time by analyzing:
the digital wallet user's risk score and KYC information, and/or
(if applicable) the risk score of the selected beneficiary,
the starting and ending locations of the transaction (e.g., the physical and/or network locations of the digital wallet user and the selected beneficiary),
the time and date of the transaction,
checking the country of birth of the digital wallet user, and
if the digital wallet user and (if applicable) the selected beneficiary are on a restricted list,
meta-data, and/or
a background check factor, and/or
the countries listed in the primary addresses of both the digital wallet user and the selected beneficiary whereby the countries' most recent Basel AML Index scores are checked, as well as to see if they are on any type of restricted list, and/or
(if needed) the procedure by and format in which the funds or items of value are to be received.
   In addition, the method also automatically determines the User Risk Score in real time by analyzing:
the user's KYC information,
the user's biometric information (at least one of a fingerprint, a voice print, and/or an iris scan),
the user's social media profile,
(if applicable) the risk scores of the user's beneficiaries,
the country of birth of the user,
whether the user is on a restricted list,
meta-data, and/or
a background check factor, and/or
the country listed in the primary address of the user—whereby the country's most recent Basel AML Index score is checked, as well as to see if it is on any type of restricted list.
   The method also permits any authorized Payout Center to bid on and fulfill a money services request by a digital wallet user based on:
the Transaction Risk Score, and/or
an optimization of the request by the digital wallet user, and
(if applicable) the selected beneficiary, and/or
the locations of the selected beneficiary, and/or
the digital wallet user,
   provided that the locations of the selected beneficiary and/or the digital wallet user are not considered a risk by the internet based money or value transfer service server, and have the required KYC information of the digital wallet user and (if applicable) the selected beneficiary automatically sent to the payout center by the Internet Based Money or Value Transfer Service server, and once the transaction is fulfilled allow the payout center to automatically provide the internet based money or value transfer service server with the transaction details which may be forwarded onto the digital wallet user and/or the selected beneficiary.

The User Risk Score maybe based on:
the user's KYC (Know Your Customer) information,
the user's biometric information (at least one of a fingerprint, a voice print, and/or an iris scan), the user's social media profile,
(if applicable) the risk scores of the user's beneficiaries,
the country of birth of the user,
whether the user is on a restricted list,
meta-data, and/or
a background check factor, and/or
the country listed in the primary address of the user-whereby the country's Basel AML Index score is checked for risk, as well as to see if it is on any type of restricted list.

The Transaction Risk Score may be based on:
the digital wallet user's risk score and KYC information, and/or
(if applicable) the risk score of the selected beneficiary,
the starting and ending locations of the transaction (e.g., the locations of the digital wallet user and the selected beneficiary),
the time and date of the transaction,
checking the country of birth of the digital wallet user, and
if the digital wallet user and (if applicable) the selected beneficiary are on a restricted list,
meta-data, and/or
a background check factor, and/or
the countries listed in the primary addresses of both the digital wallet user and the selected beneficiary—whereby the countries' Basel AML Index scores are checked, as well as to see if they are on any type of restricted list, and/or
(if necessary) the procedure by and format in which the funds or items of value are to be received.

The methods and systems disclosed herein may be implemented in any approach for achieving various aspects, and may be executed in a form of a non-transitory machine-readable medium embodying a set of instructions that, when executed by a machine, cause the machine to perform any of the operations disclosed herein.

Other features will be apparent from the accompanying drawings and from the detailed description that follows.

### BRIEF DESCRIPTION OF THE DRAWINGS

Example embodiments are illustrated by way of example and not limitation in the figures of the accompanying drawings, in which like references indicate similar elements and in which:

FIG. 1 is a network view illustrating an internet based money or value transfer service server, a digital wallet user, an active beneficiaries, and a payout centers, according to one embodiment.

FIG. 2 is an interaction view between a regulator, a banking partner, and/or a required third party with an internet based money or value transfer service system of FIG. 1, according to one embodiment.

FIG. 3A is a table view of digital wallet users and their pre-approved beneficiaries of FIG. 1, according to one embodiment.

FIGS. 3B and 3C above are a table view of money and value services transactions by the digital wallet users, according to one embodiment.

FIG. 4A is a user interface view displaying the login screen to the internet based money or value transfer service server, according to one embodiment.

FIG. 4B is a user interface view displaying various stages while completing the transaction to the selected beneficiary of FIG. 1, according to one embodiment.

FIG. 4C is a user interface view displaying various stages while completing the transaction to the selected beneficiary of FIG. 1, according to one embodiment.

FIG. 4D is a user interface view displaying a message sent by the internet based money or value transfer service server to the internet device of the selected beneficiary of FIG. 1, according to one embodiment.

FIG. 5A is a critical path view for allowing any authorized payout center to bid and fulfill a money services request by a digital wallet user of FIG. 1, according to one embodiment.

FIG. 5B is a continuation of critical path view of FIG. 5A showing additional process, according to one embodiment.

FIG. 6A is a process flow detailing the operations involved in the internet based money or value transfer Service server of FIG. 1, according to one embodiment.

FIGS. 6B and 6C are a continuation of process flow of FIG. 6A showing additional processes, according to one embodiment.

FIG. 7 is schematic diagram of a computing device that can be used to implement the methods and systems disclosed herein, according to one or more embodiments.

Other features of the present embodiments will be apparent from the accompanying drawings and from the detailed description that follows.

### DETAILED DESCRIPTION

Disclosed is an internet based money or value transfer service with a digital wallet that include systems and procedures to reduce the risk of any transaction being used for money laundering and/or terrorist financing purposes, according to one embodiment.

This disclosure relates generally to money or value transfer services, more particularly, to an internet based money or value transfer service with a digital wallet and procedures and systems to reduce the risk of any transaction being used for money laundering and/or terrorist financing purposes.

In one embodiment, an example method of the Internet Based Money or Value Transfer Service server 100 includes associating a digital wallet user 102 with the user's KYC information (based on the Financial Action Task Force requirements) and his/her biometric information, using a processor 106 and a memory 108. The method also includes limiting any financial transaction amount by a digital wallet user 102 per a period, and/or the Transaction Risk Score 349, and/or the digital wallet user's 102 risk score 320 and/or (if applicable) the risk score of the selected beneficiary 110A-S of the transaction and/or the Basel AML Index scores 306A of the countries in the primary addresses 306 of the selected beneficiary 110A-S and the digital wallet user 102.

The number of unique financial transactions 310 by a digital wallet user 102 may also be constrained per the period, and/or the Transaction Risk Score, and/or the digital wallet user's 102 risk score 312. In addition, the number of active beneficiaries 110A, e.g. remittees, by a digital wallet user 102 may be limited per the digital wallet user risk score 312. A potential beneficiary maybe restricted/rejected based on user's, primary addresses 306, his/her/its risk score, whether he/she/it is on a restricted list 118, and/or the Basel AML Index scores of the countries listed in the primary addresses 306, and/or if the countries listed in the primary addresses 306 are on any type of restricted list 118—e.g. a UK Treasury sanction's list 118N. Also, the method limits the wallet balance of a digital wallet user 102 per the period and/or the digital wallet user's risk score 312, according to one embodiment.

The deposit amount to a digital wallet is also limited per the period and/or the Transaction Risk Score 349 and/or the digital wallet user's 102 risk score 312 and/or the location where the transaction is taking place, and/or the risk score 312 of the depositor if he/she/it is not the digital wallet user 102. Further, a maximum withdrawal amount is imposed on a digital wallet user 102 per the period and/or the Transaction Risk Score 349 and/or the digital wallet user's risk score 312. The User Risk Score 312 is determined by the method in real time by analyzing the user's verified personal information, e.g., KYC (Know Your Customer) information, the user's biometric information (at least one of a fingerprint, a voice print, and/or an iris scan), the user's social media profile 218, (if applicable) the risk scores 312 of the user's beneficiaries, the country of birth 309 of the user 304, whether the user 304 is on a restricted list 118—i.e. a sanctioned list, watch list, wanted list, etc.—or person in public life list, meta-data 210, and/or a background check factor 308, and/or the country listed in the primary address 306 of the user 304, whereby the country's Basel AML Index score is checked, as well as to see if it is on any type of restricted list 118—e.g. a UK Treasury sanction's list 118N, according to one embodiment.

In addition, the method automatically determines the Transaction Risk Score 349 in real time by analyzing the digital wallet user's risk score 312 and verified personal information, e.g., verified personal information such as KYC (Know Your Customer) information, and/or (if applicable) the risk score 312 of the selected beneficiary 110A-S, the starting and ending locations of the transaction (i.e. the locations of the digital wallet user 102 and the selected beneficiary 110A-S), the time and date of the transaction, checking the country of birth of the digital wallet user 102 and if the digital wallet user 102 and (if applicable) the selected beneficiary 110A-S are on a restricted list 118—i.e. a sanctioned list, watch list, wanted list, etc.—or person in public life list, meta-data 210, and/or a background check factor 308, and/or the countries listed in the primary addresses 306 of both the digital wallet user 102 and the selected beneficiary 110A-S whereby the countries' Basel AML Index scores are checked, as well as to see if they are on any type of restricted list 118—e.g. a UK Treasury sanction's list 118N, and/or (if necessary) the procedure by and format in which the funds or items of value are to be received, according to one embodiment.

The method also permits any authorized payout center 114 to bid on and fulfill a money services request by a digital wallet user 102 based on the Transaction Risk Score 349 and/or an optimization of the request by the digital wallet user 102 and (if applicable) the selected beneficiary 110A-S, and/or the locations of the selected beneficiary 110A-S and/or the digital wallet user 102, provided that the locations of the selected beneficiary 110A-S and/or the digital wallet user 102 are not considered a risk by the Internet Based Money or Value Transfer Service server 100, and have the required verified personal information, such as KYC (Know Your Customer) information, of the digital wallet user 102 and (if applicable) the selected beneficiary 110A-S automatically sent to the payout center by the Internet Based Money or Value Transfer Service server 100, and once the transaction is fulfilled allow the payout center(s) 114 to automatically provide the Internet Based Money or Value Transfer Service server 100 with the transaction details which may be forwarded onto the digital wallet user 102 and/or the selected beneficiary 110A-S, according to one embodiment.

A regulator 202, a banking partner 204, and/or a required third party 206 may be provided a view access to the Internet Based Money or Value Transfer Service system 116. The meta-data 210 may be gathered through public and/or private sources (e.g. a government directory 214, user provided, KYC information 216, a social media profile 218, and/or a customer database 220). A regulator 202, a banking partner 204, and/or a required third party 206 may be provided reporting access to the Internet Based Money or Value Transfer Service system 116. All digital wallet user(s) 102 may be required to sign up—including (if required) pre-enrolling their beneficiaries—at an authorized center 222 where their personal and biometric details will be captured prior to being permitted to use the Internet Based Money or Value Transfer Service system 116, according to one embodiment.

An account may be provided when a customer care agent 224 of an authorized center 222 creates an account for a digital wallet user 102—including (if required) pre-enrolling the user's beneficiaries. Further, the method may include assessing employees of the authorized center(s) 222 and the digital wallet user(s) 102 (and if applicable, their beneficiaries) for risk, and based on the assessment automatically generate their User Risk Scores 312 and keep the same updated in real-time based on any changes in the data in which the assessment was based. The method may determine (e.g. using authorization module 228) if the employees of the authorized center(s) 222 and the digital wallet user(s) 102 (and if applicable, their beneficiaries) are on a restricted list 118—i.e. a sanctioned list, watch list, wanted list, etc.—or person in public life (i.e. a politically exposed person) list, and if the countries listed in the primary addresses 306 of the employees of the authorized center(s) 222 and the digital wallet user(s) 102 and (if applicable) their beneficiaries are considered a risk by the Financial Action Task Force, and/or the Basel Institute, and/or are on any type of restricted list 118—e.g. a UK Treasury sanction's list 118N, according to one embodiment.

The employees of the authorized center(s) 222 and the digital wallet user(s) 102 (and if applicable, their beneficiaries) may be verified (e.g. using verification module 230) through the provided verified personal information such as KYC (Know Your Customer) information—including multiple Government ID's, proof of the provided primary addresses 306, biometric information, etc. The method of the Internet Based Money or Value Transfer Service server 100 may include verifying (e.g. using verification module 230) the primary addresses 306 of the employees of the authorized center(s) 222 and the digital wallet user(s) 102 (and if applicable, their beneficiaries) using a processor 106 and the memory 108. Biometric information of the employees of the authorized center(s) 222 and the digital wallet user(s) 102 (and if applicable, their beneficiaries) may be captured and validated (e.g. using verification module 230). The biometric information may be a fingerprint, a voice print, and/or an iris scan. The countries of birth of the employees of the authorized center(s) 222 and the digital wallet user(s) 102 (and if required, their beneficiaries) may be verified (e.g. using verification module 230) and accessed for risk based on the countries' Basel AML Index scores and/or if they are on any type of restricted list—e.g. UK Treasury List, using the processor 106 and the memory 108, according to one embodiment.

The risk score of a user 304 (“User Risk Score” 312) is based on his/her/its verified personal information such as KYC (Know Your Customer) information, the user's biometric information (at least one of a fingerprint, a voice print, and/or an iris scan), the user's social media profile 218, (if applicable) the risk scores 312B of his/her/its beneficiaries, the country of birth of the user 302, whether the user 304 is on a restricted list 118—i.e. a sanctioned list, watch list, wanted list, etc.—or person in public life list, meta-data 210, and/or a background check factor 308, and/or the country listed in the primary address 306 of the user 304, whereby the country's Basel AML Index score 306A is checked, as well as to see if it is on any type of restricted list 118—e.g. a UK Treasury sanction's list 118N, according to one embodiment.

The risk score of a transaction (“Transaction Risk Score 349) may be based on the digital wallet user's risk score 312 and verified personal information such as KYC (Know Your Customer) information, and/or (if applicable) the risk score 312 of the selected beneficiary 110A-S, the starting and ending locations of the transaction (i.e. the locations of the digital wallet user 102 and the selected beneficiary 110A-S), the time and date of the transaction, checking the country of birth of the digital wallet user 102 and if the digital wallet user 102 and (if applicable) the selected beneficiary 110A-S are on a restricted list 118—i.e. a sanctioned list, watch list, wanted list, etc.—or person in public life list, meta-data 210, and/or a background check factor 308, and/or the countries listed in the primary addresses 306 of both the digital wallet user 102 and the selected beneficiary 110A-S whereby the countries' Basel AML Index scores are checked, as well as to see if they are on any type of restricted list 118—e.g. a UK Treasury sanction's list 118N, and/or (if necessary) the procedure by and format in which the funds or items of value are to be received, according to one embodiment.

The Internet Based Money or Value Transfer Service system 116 is accessible from an internet device 105 with an “active” data connection over an Internet Protocol (IP) based network infrastructure. A short message 452 may be sent to a digital wallet user 102 and (if applicable) the selected beneficiary 110A-S confirming the transaction, including the time and/or the location of the transaction, the transaction amount, the digital wallet user's 102 account balance, and/or a set of details of the receipt of funds of the transaction. The risk score 312 of a digital wallet user 102 may be adjusted if the digital wallet user 102 provides additional verified personal information such as KYC (Know Your Customer) or other personal information. An option may be provided to allow a digital wallet user 102 to select from a list of authorized payout center(s) 114—e.g. remittance vendors—to complete a transaction request or to conduct a direct wallet-to-wallet (i.e. digital wallet user 102 to digital wallet user 102) transaction, according to one embodiment.

In another embodiment, the method of the Internet Based Money or Value Transfer Service server 100 includes associating a digital wallet user 102 with the user's verified personal information such as KYC (Know Your Customer) information (based on the Financial Action Task Force requirements) and his/her biometric information, using a processor 106 and a memory 108. The method also includes limiting any financial transaction amount by a digital wallet user 102 per a period, and/or the Transaction Risk Score 349, and/or the digital wallet user's 102 risk score 312 and/or (if applicable) the risk score of the selected beneficiary 110A-S of the transaction and/or the Basel AML Index scores 306A of the countries in the primary addresses 306 of the selected beneficiary 110A-S and the digital wallet user 102. The number of unique financial transactions 310 by a digital wallet user 102 may also be constrained per the period, and/or the Transaction Risk Score, and/or the digital wallet user's 102 risk score 312. In addition, the number of active beneficiaries 110A—e.g. remittees—by a digital wallet user 102 may be limited per the risk score 312 of the digital wallet user 102, according to one embodiment.

A potential beneficiary maybe restricted/rejected based on user's, primary address 306, user's, risk scores, whether he/she/it is on a restricted list 118, and/or the Basel AML Index scores 306A of the countries listed in the primary addresses 306, and/or if the countries listed in the primary addresses 306 are on any type of restricted list 118—e.g. a UK Treasury sanction's list 118N. Also, the method limits the wallet balance of a digital wallet user 102 per the period and/or the digital wallet user's risk score 312. The deposit amount to a digital wallet may also be limited per the period and/or based on the Transaction Risk Score 349 and/or the digital wallet user's 102 risk score 312 and/or the location where the transaction is taking place, and/or the risk score 312 of the depositor if he/she/it is not the digital wallet user 102. Further, a maximum withdrawal amount may be imposed on a digital wallet user 102 per the period and/or based on the Transaction Risk Score 349 and/or the digital wallet user's risk score 312, according to one embodiment.

The method automatically determines the User Risk Score 312 in real time by analyzing the user's verified personal information, e.g., KYC (Know Your Customer) information, the user's biometric information (at least one of a fingerprint, a voice print, and/or an iris scan), the user's social media profile 218, (if applicable) the risk scores 312B of the user's beneficiaries, the country of birth 309 of the user 304, whether the user 304 is on a restricted list 118—i.e. a sanctioned list, watch list, wanted list, etc.—or person in public life list, meta-data 210, and/or a background check factor 308, and/or the country listed in the primary address 306 of the user 304, whereby the country's Basel AML Index score 306A is checked, as well as to see if it is on any type of restricted list 118—e.g. a UK Treasury sanction's list 118N, according to one embodiment. [0054] In addition, the method automatically determines the Transaction Risk Score 349 in real time by analyzing the digital wallet user's risk score 312 and verified personal information, e.g., KYC (Know Your Customer) information, and/or (if applicable) the risk score 312 of the selected beneficiary 110A-S, the starting and ending locations of the transaction (i.e. the locations of the digital wallet user 102 and the selected beneficiary 110A-S), the time and date of the transaction, checking the country of birth of the digital wallet user 102 and if the digital wallet user 102 and (if applicable) the selected beneficiary 110A-S are on a restricted list 118—i.e. a sanctioned list, watch list, wanted list, etc.—or person in public life list, meta-data 210, and/or a background check factor 308, and/or the countries listed in the primary addresses 306 of both the digital wallet user 102 and the selected beneficiary 110A-S whereby the countries' Basel AML Index scores are checked, as well as to see if they are on any type of restricted list 118 or sanction's list 118N, and/or (if necessary) the procedure by and format in which the funds or items of value are to be received.

The method also permits any authorized payout center 114 to bid on and fulfill a money services request by a digital wallet user 102 based on the Transaction Risk Score 349 and/or an optimization of the request by the digital wallet user 102 and (if applicable) the selected beneficiary 110A-S, and/or the locations of the selected beneficiary 110A-S and/or the digital wallet user 102, provided that the locations of the selected beneficiary 110A-S and/or the digital wallet user 102 are not considered a risk by the Internet Based Money or Value Transfer Service server 100, and have the required verified personal information, e.g., KYC (Know Your Customer) information of the digital wallet user 102 and (if applicable) the selected beneficiary 110A-S automatically sent to the payout center(s) 114 by the Internet Based Money or Value Transfer Service server 100, and once the transaction is fulfilled allow the payout center(s) 114 to automatically provide the Internet Based Money or Value Transfer Service server 100 with the transaction details which may be forwarded onto the digital wallet user 102 and/or the selected beneficiary 110A-S. In addition, the method assesses employees of the authorized center(s) 222 and the digital wallet user(s) 102 (and if applicable, their beneficiaries) for risk, and based on the assessment automatically generate their User Risk Scores 312 and keep the same updated in real-time based on any changes in the data in which the assessment was based, according to one embodiment.

The method may determine (e.g. using authorization module 229) if the employees of the authorized center(s) 222 and the digital wallet user(s) 102 (and if applicable, their beneficiaries) are on a restricted list 118—i.e. a sanctioned list, watch list, wanted list, etc.—or person in public life (i.e. a politically exposed person) list, and if the countries listed in the primary addresses 306 of the employees of the authorized center(s) and the digital wallet user(s) 102 and (if applicable) their beneficiaries are considered a risk by the Financial Action Task Force, and/or the Basel Institute, and/or are on any type of restricted list 118—e.g. a UK Treasury sanction's list 118N. Further, the method includes verifying (e.g. using verification module 230) the employees of the authorized center(s) 222 and the digital wallet user(s) 102 (and if applicable, their beneficiaries) through the provided verified personal information, such as KYC (Know Your Customer) information—including multiple Government ID's, proof of the primary addresses, biometric information, etc. The method also includes verifying (e.g. using verification module 230) the primary addresses 306 of the employees of the authorized center(s) 222 and the digital wallet user(s) 102 (and if applicable, their beneficiaries) using a processor 106 and the memory 108, according to one embodiment.

The method of the Internet Based Money or Value Transfer Service server 100 includes capturing and validating biometric information of the employees of the authorized center(s) 222, the digital wallet user(s) 102, (and if required, their beneficiaries). The biometric information may be a fingerprint, a voice print, and/or an iris scan. The method also includes verifying (e.g. using verification module 230) and assessing for risk (based on the country's, Basel AML Index score 306A) the countries of birth of the employees of the authorized center(s) 222 and the digital wallet user(s) 102 (and if applicable, their beneficiaries) based on the country's Basel AML Index scores and/or if they are on any type of restricted—e.g. UK Treasury List, using the processor 106 and the memory 108, according to one embodiment. [0058] In yet another embodiment, an example method of the Internet Based Money or Value Transfer Service server 100 includes associating a digital wallet user 102 with the user's verified personal information such as KYC (Know Your Customer) information (based on the Financial Action Task Force requirements) and his/her biometric information, using a processor 106 and a memory 108. The method also includes limiting any financial transaction amount by a digital wallet user 102 per a period, and/or the Transaction Risk Score 349, and/or the digital wallet user's 102 risk score 312 and/or (if applicable) the risk score of the selected beneficiary 110A-S of the transaction and/or the Basel AML Index scores 306A of the countries in the primary addresses 306 of the selected beneficiary 110A-S and the digital wallet user 102. The number of unique financial transactions 310 by a digital wallet user 102 may also be constrained per the period, and/or the Transaction Risk Score 349, and/or the digital wallet user's 102 risk score 312. In addition, the number of active beneficiaries 110A—e.g. remittees—by a digital wallet user 102 may be limited per the risk score 312 of the digital wallet user 102. Also, the method limits the wallet balance of a digital wallet user 102 per the period and/or the digital wallet user's risk score 312.

The deposit amount to a digital wallet may also be limited per the period and/or based on the Transaction Risk Score 349 and/or the digital wallet user's 102 risk score 312 and/or the location where the transaction is taking place, and/or the risk score 312 of the depositor if he/she/it is not the digital wallet user 102, according to one embodiment.

Further, a maximum withdrawal amount may be imposed on a digital wallet user 102 per the period and/or based on the Transaction Risk Score 349 and/or the digital wallet user's risk score 312. The method of the Internet Based Money or Value Transfer Service server 100 includes automatically determining the Transaction Risk Score 349 in real time by analyzing the digital wallet user's risk score 312 and verified personal information such as KYC (Know Your Customer) information, and/or (if applicable) the risk score 312B of the selected beneficiary 110A-S, the starting and ending locations of the transaction (i.e. the locations of the digital wallet user 102 and the selected beneficiary 110A-S), the time and date of the transaction, checking the country of birth of the digital wallet user 102 and if the digital wallet user 102 and (if applicable) the selected beneficiary 110A-S are on a restricted list 118—i.e. a sanctioned list, watch list, wanted list, etc.—or person in public life list, meta-data 210, and/or a background check factor 308, and/or the countries listed in the primary addresses 306 of both the digital wallet user 102 and the selected beneficiary 110A-S whereby the countries' Basel AML Index scores are checked, as well as to see if they are on any type of restricted list (118—e.g. a UK Treasury sanction's list) 118N, and/or (if necessary) the procedure by and format in which the funds or items of value are to be received. In addition, the method also automatically determines the User Risk Score 312 in real time by analyzing the user's verified personal information, e.g., KYC (Know Your Customer) information, the user's biometric information (at least one of a fingerprint, a voice print, and/or an iris scan), the user's social media profile 218, (if applicable) the risk scores 312B of the user's beneficiaries, the country of birth 309 of the user 304, whether the user 304 is on a restricted list 118—i.e. a sanctioned list, watch list, wanted list, etc.—or person in public life list, meta-data 210, and/or a background check factor 308, and/or the country listed in the primary address 306 of the user 304, whereby the country's rating, such as a Basel AML Index score 306A is checked, as well as to see if it is on any type of restricted list 118—e.g. a UK Treasury sanction's list 118N, to one embodiment.

The method also permits any authorized payout center 114 to bid on and fulfill a money services request by a digital wallet user 102 based on the Transaction Risk Score 349 and/or an optimization of the request by the digital wallet user 102 and (if applicable) the selected beneficiary 110A-S, and/or the locations of the selected beneficiary 110A-S and/or the digital wallet user 102, provided that the locations of the selected beneficiary 110A-S and/or the digital wallet user 102 are not considered a risk by the Internet Based Money or Value Transfer Service server 100, and have the required verified personal information, e.g., KYC (Know Your Customer) information of the digital wallet user 102 and (if applicable) the selected beneficiary 110A-S automatically sent to the payout center(s) 114 by the Internet Based Money or Value Transfer Service server 100, and once the transaction is fulfilled allow the payout center(s) 114 to automatically provide the Internet Based Money or Value Transfer Service server 100 with the transaction details which may be forwarded onto the digital wallet user 102 and/or the selected beneficiary 110A-S, according to one embodiment.

The risk score 312 of a user 304 (“User Risk Score” 312) maybe based on the user's verified personal information such as KYC (Know Your Customer) information, the user's biometric information (at least one of a fingerprint, a voice print, and/or an iris scan), the user's social media profile 218, (if applicable) the risk scores 312B of the user's beneficiaries, the country of birth 309 of the user 304, whether the user 304 is on a restricted list 118—i.e. a sanctioned list, watch list, wanted list, etc.—or person in public life list, meta-data 210, and/or a background check factor 308, and/or the country listed in the primary address 306 of the user 304, whereby the country's rating, e.g., Basel AML Index score, 306A is checked, as well as to see if it is on any type of restricted list 118—e.g. a UK Treasury sanction's list 118N, according to one embodiment.

The risk score of a transaction (“Transaction Risk Score”) 349 may be based on the digital wallet user's risk score 312 and verified personal information such as KYC (Know Your Customer) information, and/or (if applicable) the risk score 312B of the selected beneficiary 110A-S, the starting and ending locations of the transaction (i.e. the locations of the digital wallet user 102 and the selected beneficiary 110A-S), the time and date of the transaction, checking the country of birth of the digital wallet user 102 and if the digital wallet user 102 and (if applicable) the selected beneficiary 110A-S are on a restricted list 118—i.e. a sanctioned list, watch list, wanted list, etc.—or person in public life list, meta-data 210, and/or a background check factor 308, and/or the countries listed in the primary addresses 306 of both the digital wallet user 102 and the selected beneficiary 110A-S whereby the countries' rating, such as Basel AML Index scores, are checked, as well as to see if they are on any type of restricted list 118—e.g. a UK Treasury sanction's list 118N, and/or (if necessary) the procedure by and format in which the funds or items of value are to be received, according to one embodiment.

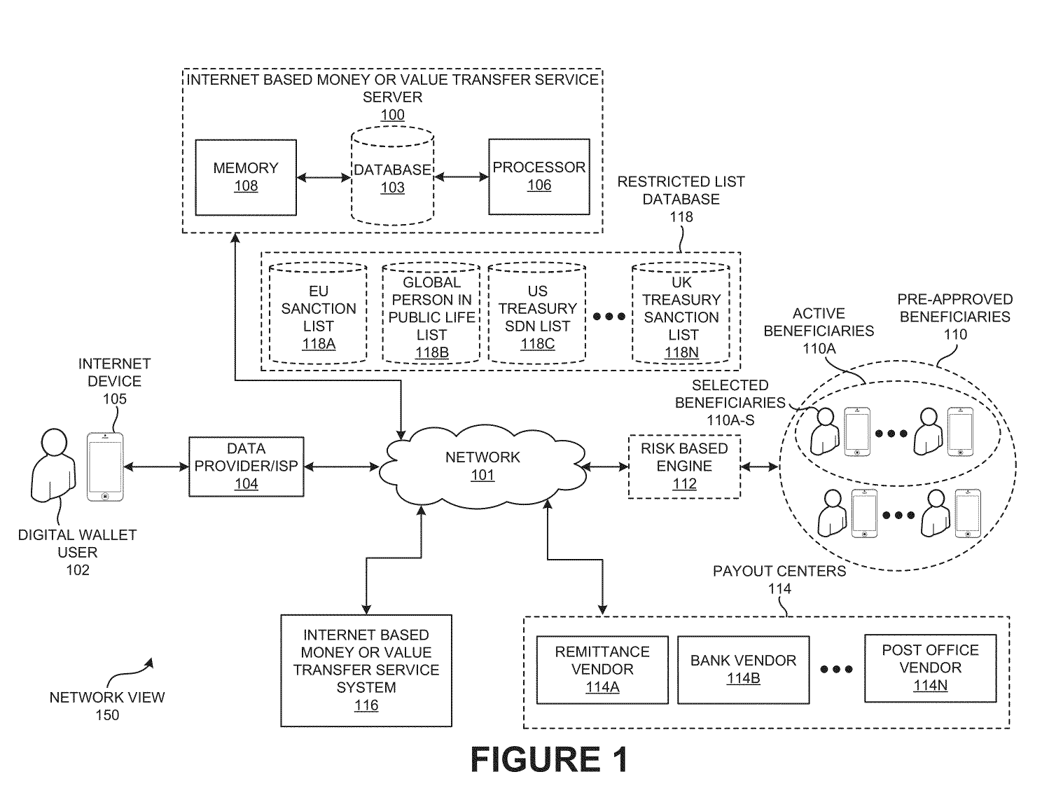

FIG. 1 is a network view 150 illustrating an internet based money or value transfer service server 100, a digital wallet user 102, an active beneficiaries 110A, and a payout center(s) 114, according to one embodiment.

Particularly, FIG. 1 shows the internet based money or value transfer service server 100, a network 101, the digital wallet user 102, a database 103, a data provider/ISP 104, an internet device 105, a processor 106, a memory 108, pre-approved beneficiaries 110, the active beneficiaries 110A, selected beneficiaries 110A-S, a risk based engine 112, the payout center(s) 114, a remittance vendor 114A, a bank vendor 114B, a post office vendor 114N, an internet based money or value transfer service system 116, a restricted list 118, an EU sanction list 118A, a global person in public life list 118B, an US treasury SDN list 118C, an UK Treasury sanction's list 118N, according to one embodiment, according to one embodiment. [0065] FIG. 1 illustrates the internet based money or value transfer service server 100 with the database 103 coupled to the memory 108 and the processor 106, according to one embodiment. The digital wallet user 102 with the Internet device 105 may be connected to the internet based money or value transfer service server 100 through the data provider/ISP 104 and the network 101. The internet based money or value transfer service system 116 may be coupled to the internet based money or value transfer service server 100 through the network 101. The active beneficiaries 110A from the pre-approved beneficiaries 110 may be coupled to the internet based money or value transfer service server 100 through the network 101. The risk based engine 112 may be used to determine the risk level of a transaction by the digital wallet user 102 and/or between the selected beneficiaries 110A-S. The Payout Center(s) 114 may be coupled to the internet based money or value transfer service server 100 through the network 101, according to one embodiment.

The internet based money or value transfer service server 100 may be a software (e.g. a program, an application) and/or hardware, running on one or multiple computers that manage resources and services of the network 101, according to one embodiment. The network 101 may be a group of two or more computers and/or other devices (e.g. peripherals, terminals) connected together by the communication lines, according to one embodiment. The digital wallet user 102 may be any entity (e.g. a natural person, a legal person, a software program or application, a process) that utilizes the internet based money or value transfer service system 116 for money services financial transactions—e.g. remitting funds or any item of value to a beneficiary (e.g. a selected beneficiary 110A-S), according to one embodiment.

The database 103 may be a collection of data and/or information organized in such a way that it can be accessed, managed, and/or updated, according to one embodiment. The data provider/ISP 104 may be a certified provider of services that owns and/or controls all the elements necessary to sell and/or deliver the connectivity services to a user (e.g. a digital wallet user 102, a selected beneficiary 110A-S), according to one embodiment. The internet device 105 may be a data processing device with an internet connection enabled, through which the user will make the transaction, according to one embodiment. The processor 106 may be a central unit of the computer containing the logic circuitry to perform all the basic instructions of a computer program, according to one embodiment.

The memory 108 may be a device used to store data or programs (sequences of instructions) on a temporary or permanent basis for use in an electronic digital computer, according to one embodiment. The pre-approved beneficiaries 110 may include any entity (e.g. a natural person, a legal person, a software program or application) that have been vetted and approved by the internet based money or value transfer service server 100 to receive funds 318 and/or any item of value from a digital wallet user 102, according to one embodiment. The active beneficiaries 110A maybe a pre-approved beneficiary (pre-approved beneficiaries 110) that can receive funds or any item of value from a digital wallet user 102 whether directly—i.e. digital wallet user 102 to digital wallet user 102—or via an authorized payout center 114 without the digital wallet user 102 first requiring a customer care agent 224 to initiate and/or process the transaction, according to one embodiment.

The selected beneficiary 110A-S maybe an active beneficiaries 110A that has been selected by a digital wallet user 102 to be the recipient of funds or any item of value—e.g. remittances—during a money services transaction, according to one embodiment. The risk based engine 112 may be a set of instructions that determines User Risk Score 312 and/or Transaction Risk Score 349 in real time. The risk score of a user 304 (“User Risk Score 312) is based on his/her/its verified personal information such as KYC (Know Your Customer) information, the user's biometric information (at least one of a fingerprint, a voice print, and/or an iris scan), the user's social media profile 218, (if applicable) the risk scores of user's beneficiaries, the country of birth of the user 307, whether the user 304 is on a restricted list 118—i.e. a sanctioned list, watch list, wanted list, etc.—or person in public life list, meta-data 210, and/or a background check factor 308, and/or the country listed in the primary address of the user 304, whereby the country's rating, e.g., Basel AML Index score, is checked for risk, as well as to see if it is on any type of restricted list 118—e.g. a UK Treasury sanction's list 118N, according to one embodiment.

Further, the risk score of the transaction (“Transaction Risk Score”) 349 may be ascertained by analyzing the digital wallet user's risk score and verified personal information such as KYC (Know Your Customer) information, and/or (if applicable) the risk score of the selected beneficiary 110A-S, the starting and ending locations of the transaction (i.e. the locations of the digital wallet user 102 and the selected beneficiary 110A-S), the time and date of the transaction, checking the country of birth of the digital wallet user 102 and if the digital wallet user 102 and (if applicable) the selected beneficiary 110A-S are on a restricted list 118—i.e. a sanctioned list, watch list, wanted list, etc.—or person in public life list, meta-data 210, and/or a background check factor 308, and/or the countries listed in the primary addresses 306 of both the digital wallet user 102 and the selected beneficiary 110A-S whereby the countries' rating, e.g., Basel AML Index scores, are checked, as well as to see if they are on any type of restricted list 118—e.g. a UK Treasury sanction's list 118N, and/or (if necessary) the procedure by and format in which the funds or items of value are to be received, according to one embodiment.

The payout center(s) 114 may be businesses with valid licenses to conduct money or value transfer services locally, nationally, and/or internationally; and/or financial settlements on behalf of the Internet Based Money or Value Transfer Service system 116. The payout center(s) 114 may be a remittance vendor 114A, a bank vendor 114B, and a post office vendor 114N, according to one embodiment. The internet based money or value transfer service system 116 may be a platform that allows for the transaction of money or value transfer services both domestically and internationally over a network 101, according to one embodiment.

A restricted list 118 may be a sanctioned list, watch list, wanted list, or a person in public life list, meta-data 210, and/or a background check factor 308, and/or the countries listed in the primary addresses 306 of both the digital wallet user 102 and the selected beneficiary 110A-S whereby the countries' rating, e.g., Basel AML Index scores, are checked for risk, as well as to see if they are on any type of restricted list 118). The restricted list database 118 may comprise of one or more restricted list 118—i.e. a sanctioned list, watch list, wanted list, etc.—or person in public life list, with frequently updated information and/or continuous advancement, with global accessibility, according to one embodiment.

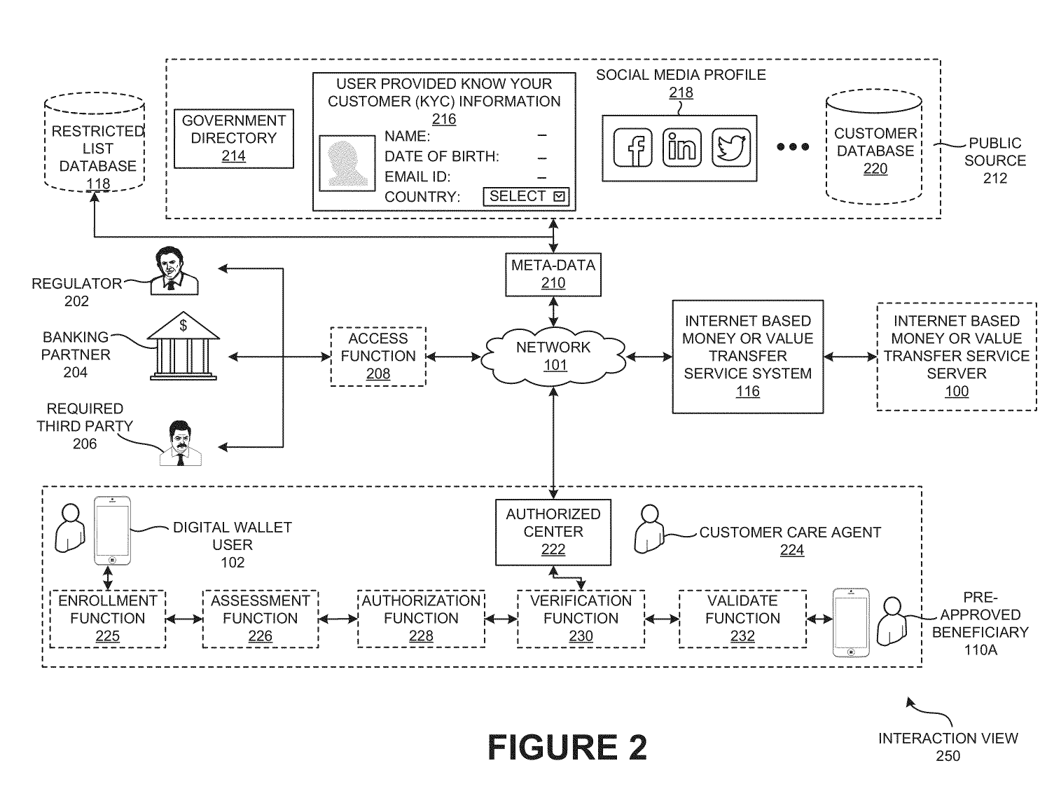

FIG. 2 is an interaction view 250 between a regulator 202, a banking partner 204, and/or a required third party 206 with an internet based money or value transfer service system 116 of FIG. 1, according to one embodiment.

Particularly, FIG. 2 illustrates the regulator 202, the banking partner 204, the required third party 206, an access module 208, a meta-data 210, a public source 212, a government directory 214, an user provided KYC information 216, a social media profile 218, a customer database 220, an authorized center 222, a customer care agent 224, an enrollment module 225, an assessment module 226, an authorization module 228, a verification module 230, and a validate module 232, according to one embodiment.

The regulator 202 may supervise licensed money or value transfer services businesses for compliance with the requirements and/or respond to breaches of the requirements through obtaining undertakings, giving directions, imposing penalties, and/or revoking a money or value transfer services businesses license. The regulator 202 may be permitted to access (e.g. view access and/or reporting access) through an access module 208. The banking partner 204 may be a private and/or government equity firm and/or organization focused on accepting deposits and channeling those deposits into lending activities, according to one embodiment. The banking partner 204 may be permitted to access (e.g. view access and/or reporting access) through an access module 208, according to one embodiment.

The required third party (e.g. an audit firm) 206 may perform an inspection in accordance with specific laws and/or rules required by certain jurisdictions or entities on the internet based money or value transfer service transactions. The required third party 206 may be permitted to access (e.g. view access and/or reporting access) through an access module 208, according to one embodiment. The access module 208 may allow the regulator 202, the banking partner 204 and/or the required third party 206 to view the internet based money or value transfer service system 116, according to one embodiment. The access module 208 may facilitate a reporting access to the internet based money or value transfer service system 116, according to one embodiment.

The meta-data 210 may summarize the basic information about a digital wallet user 120 and/or the user's, active beneficiaries 110A, according to one embodiment. The public source 212 may offer information about the digital wallet user 102 and/or their pre-approved beneficiaries 110 through various mediums including the government directory 214, user provided KYC information 216, a social media profile 218, and/or the customer database 220, according to one embodiment. The government directory 214 may be recognized as one-point source of valuable information managed by the government of the particular country, according to one embodiment. The government directory 214 may combine government departments, state government and/or local government but also a range of services provided by different businesses throughout the country, with frequently updated information and/or continuous advancements. The government directory 214 may have global accessibility, according to one embodiment.

The restricted list (restricted list database 118) may comprise of one or more restricted lists 118—i.e. a sanctioned list, watch list, wanted list, etc.—or person in public life list, with frequently updated information and/or continuous advancement. The restricted list (restricted list database 118) may have global accessibility, according to one embodiment. The user provided KYC information 216 may include at a minimum the required, KYC information 216 as required by the Financial Action Task Force for a user 102, according to one embodiment. The social media profile 218 may be a web page of the social network websites (e.g. Facebook®, Twitter®, LinkedIn®) that discloses personal information—e.g. name, age, profession, location, and/or information that portrays users (e.g. the digital wallet user 102 and/or the pre-approved beneficiaries 110) in certain ways, according to one embodiment.

The customer database 220 may consists of digital wallet user(s) 102, and/or their beneficiaries, and/or their transactions, accessible via the network 101. The data (e.g. name, Id number, gender, age, marital status, employer, primary address 306, risk scores, wallet balance, pre-approved beneficiaries 110, # of transactions for the period, etc.) in the customer database 220 may be compiled using various resources and/or updated on an on-going basis, according to one embodiment. The authorized center 222 may be any place of business that has a valid business license and that is opened to the public, according to one embodiment. The customer care agent 224 of an authorized center 222 may be a person responsible for managing the accounts of the digital wallet user(s) 102, including pre-enrolling their beneficiaries, according to one embodiment.

The enrollment module 225 may include a set of instructions that allows a customer care agent 224 to capture the provided KYC information 216 and compile all of the information from the assessment module 226, the authorization module 228, the verification module 230, and the validate module 232, of the employees of the authorized center(s) 222, the digital wallet user(s) 102 and/or their beneficiaries, and create an account on the internet based money or value transfer service server 100 for the same, according to one embodiment. The assessment module 226 may include a set of instructions that assesses the risk level of the employees of the authorized center(s) 222, the digital wallet user(s) 102 and/or their beneficiaries, and generate their User Risk Scores 312 from the same, according to one embodiment.

The authorization module 228 may include a set of instructions that determines whether the employees of the authorized center(s) 222 and the digital wallet user(s) 102 (and if applicable, their beneficiaries) are on a restricted list 118—i.e. a sanctioned list, watch list, wanted list, etc.—or person in public life (i.e. a politically exposed person) list, and if the countries listed in the primary addresses 306 of the employees of the authorized center(s) 222 and the digital wallet user(s) 102 and (if applicable) their beneficiaries are considered a risk by a rating organization, such as the FATF, the Basel Institute, or other rating or evaluation organizations or services, and/or are on any type of restricted list 118—e.g. a UK treasury sanction's list 118N, according to one embodiment.

The verification module 230 may include a set of instructions that authenticates the employees of the authorized center 222, digital wallet user(s) 102 and their pre-approved beneficiaries 110 on the basis of the provided KYC information 216—including multiple government Id's, proof of the addresses, biometric information, etc. The verification module 230 may also include the set of instructions that confirms the primary addresses 306 and/or the countries of birth (e.g. birth place) of the employees of the authorized center(s) 222, the digital wallet user(s) 102 and their pre-approved beneficiaries 110, according to one embodiment. The validate module 232 may include a set of instructions that includes inspecting the biometric information (e.g. a finger print, a voice print, iris scan) of the employees of the authorized center(s) 222, the digital wallet user(s) 102 and/or their beneficiaries, according to one embodiment.

FIG. 2 illustrates the regulator 202, the banking partner 204, and/or required third party 206 communicatively coupled to the internet based money or value transfer service system 116 through the network 101. The access module 208 may be associated with the regulator 202, the banking partner 204, and/or a required third party 206 to the internet based money or value transfer service system 116 through the network 101. The public source 212 may be associated with the meta-data 210. The meta-data 210 may be associated with the internet based money or value transfer service system 116 through the network 101, according to one embodiment. The customer care agent 224 of the authorized center 222, the digital wallet user 102 and active beneficiaries 110A may be communicatively coupled to the internet based money or value transfer service system 116 through the network 101. The internet based money or value transfer service system 116 may be associated with the internet based money or value transfer service server 100. The assessment module 226, the verification module 230, the validate module 232, the authorization module 228, and the enrollment module 225, may be associated with an authorized center 222, a digital wallet user 102, and a pre-approved beneficiaries 110, according to one embodiment.

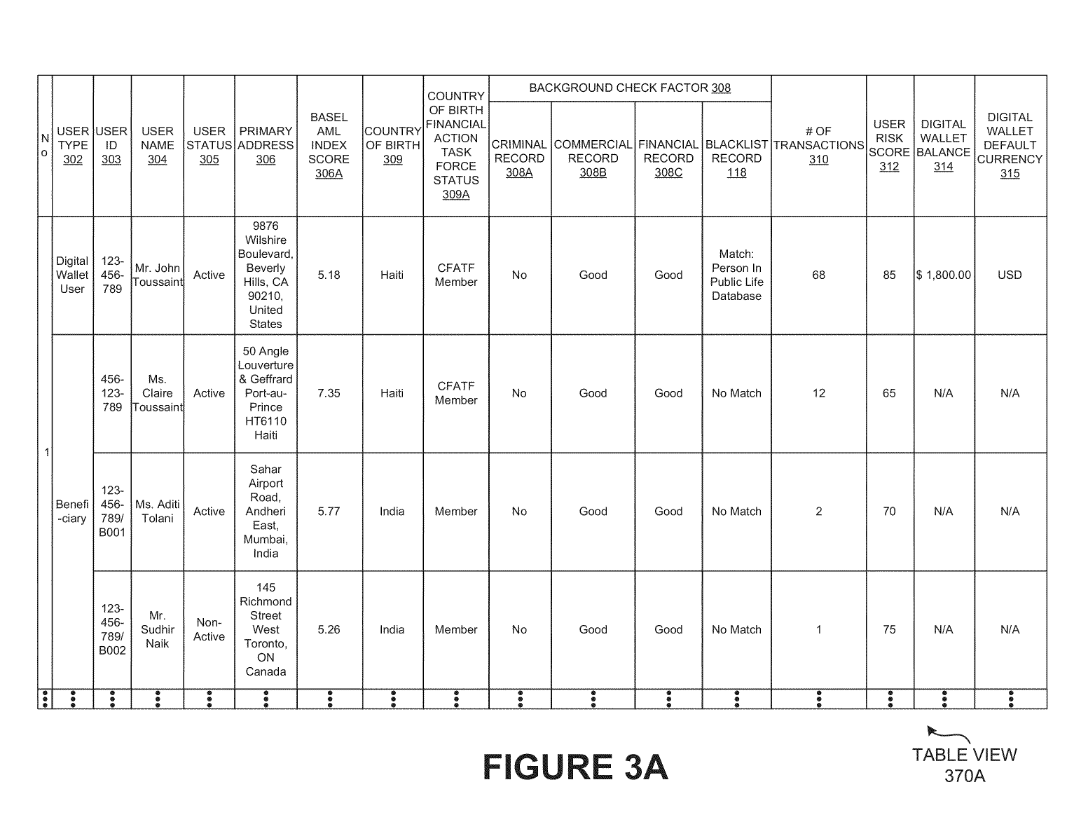

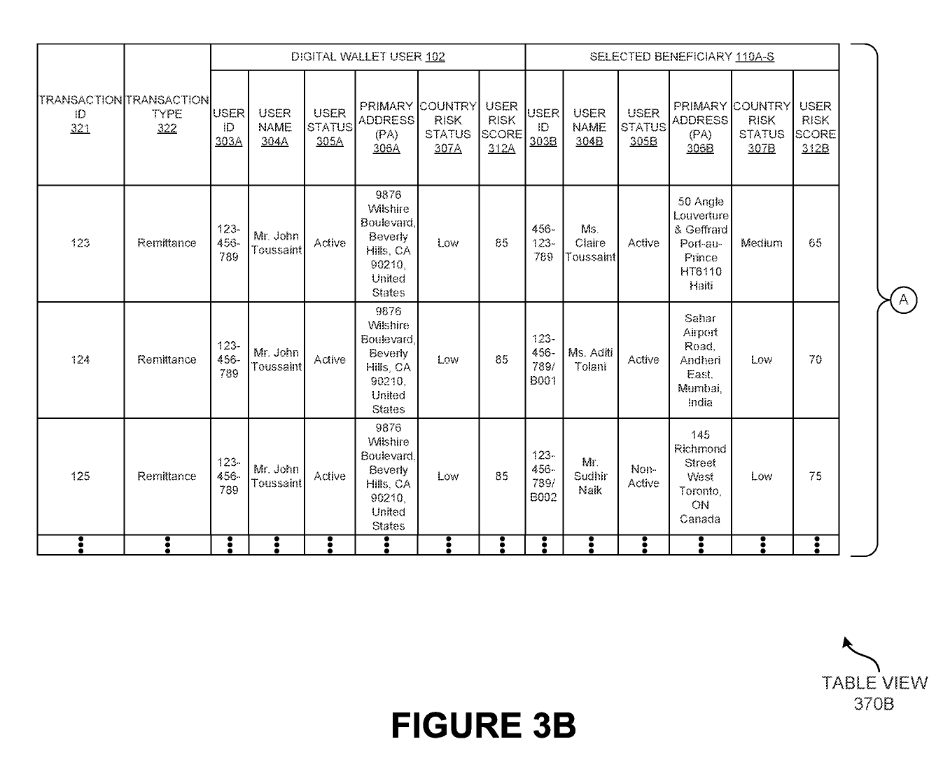

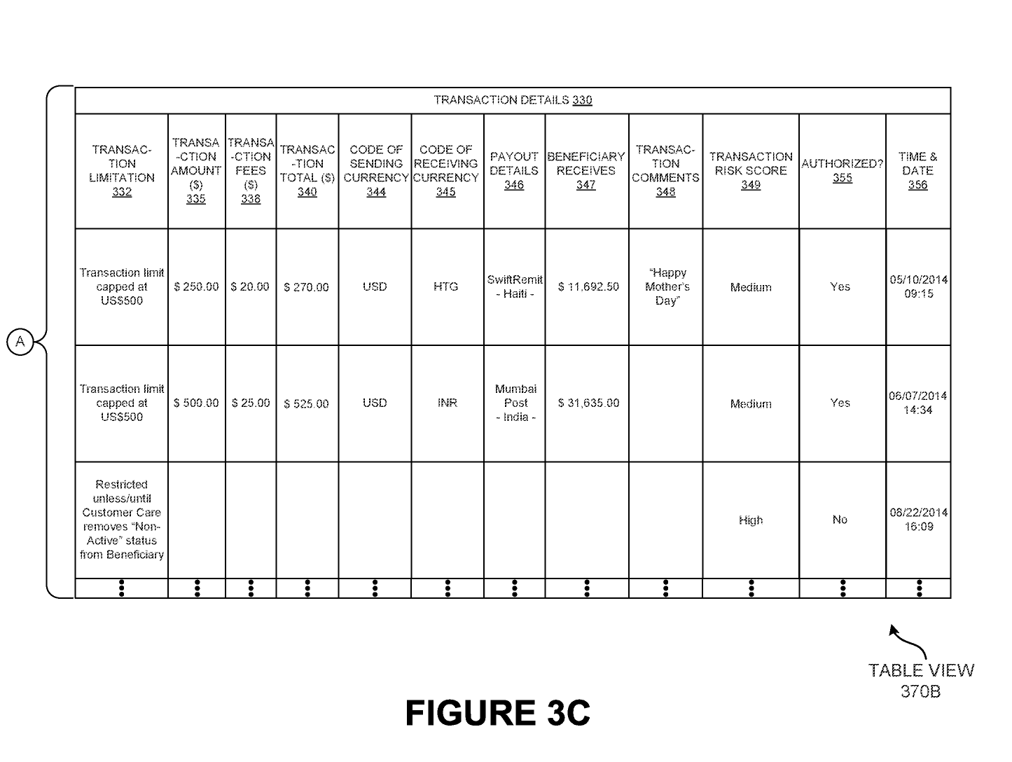

FIG. 3A is a table view 350A of digital wallet user(s) 102 (i.e. Mr. John Toussaint, Ms. Claire Toussaint, Mr. Parker Evans, Blue Sky Supermarket, Phone Company Co., Power Utility Co., and Mr. E. Jay Saunders) and their pre-approved beneficiaries 110 (i.e. Ms. Claire Toussaint, Ms. Aditi Tolani, Mr. Sudhir Naik, and Mr. Loy Yahui) of FIG. 1, according to one embodiment.

A number of example fields are illustrated in the table view 350A including fields designating a type of user 302, a user ID 303, names of the users (user name 304), statuses of the users (user status 305), primary addresses 306 of the users, and the primary addresses country rating, e.g., Basel AML Index scores, countries of birth of the user(s) 302 and their rating, e.g., Basel AML Index scores, 307A, the background checks (e.g. a criminal record 308A, a commercial record 308B, a financial record 308C, and a restricted list database 118), a # of transactions attributed to the user 304, User Risk Score 312, digital wallet balances of the users 102, and a digital wallet default currency 315, according to one embodiment.

The user type 302 identifies the type of user 304, which may include employees of the authorized center(s) 222, the digital wallet user(s) 102 and their pre-approved beneficiaries 110. The user Id 303 may include a unique identifier that is tied to a user's (user 302) account and used for identification purposes. The user name 304 may include the legal names of the user(s) 302. The user status 305 may identify if a user 304 is in an active state—i.e. they can engage in a transaction—or in a non-active state—i.e. they cannot engage in a transaction unless the transaction is conducted by a customer care agent 224 of the internet based money or value transfer service system 116. The primary address 306 may be the main legal address of a user 304, with the primary address country rating 306A, e.g., Basel AML Index score, being the score assigned to the country (associated with the primary address 306) in the Basel Institute AML Index, according to one embodiment.

The country of birth 309 may be the country where a user 304 was born, with the country of birth 309 rating, e.g., Basel AML Index score 306A being the score assigned to the country of birth 309 in the Basel Institute AML Index, according to one embodiment. The background check factor (background check) may include investigation of various factors (e.g. criminal record(s) 308A, commercial record(s) 308B, financial record(s) 308C, and restricted list 118) that may be helpful to determine the risk of a transaction by a digital wallet user 102 or between a digital wallet user 102 and a selected beneficiary 110A-S. The criminal record(s) 308A of the user(s) 304 may include criminal history, used by the internet based money or value transfer service server 100 to ascertain their trustworthiness, according to one embodiment.

The commercial record 308B may be a record that stores the details of the transaction(s) 310 by the user(s) 304. The financial record(s) 308C of the user(s) 304 may be the data representing their financial activities. The restricted list database 118 may comprise of one or more restricted list 118 or person in public life list, with frequently updated information and/or continuous advancement, with global accessibility, according to one embodiment. The # of transaction(s) 310 may include the total number of money service transactions that transverse through the internet based money or value transfer service system 116 on behalf of a user 304. The User Risk Score 312 may be the risk score of a user 304, which is calculated based on the user's KYC information 216, the user's 102 biometric information (at least one of a fingerprint, a voice print, and/or an iris scan), the user's 102 social media profile 218, (if applicable) the user risk scores (User Risk Score 312) of the user's 102 beneficiaries, the country of birth 309 of the user 102, whether the user 102 is on restricted list 118 or person in public life list 118B, meta-data 210, and/or a background check factor 308, and/or the country listed in the primary address 306 of the user 102, whereby the country's rating, e.g., Basel AML Index score 306A is checked, as well as to see if it is on any type of restricted list 118—e.g. a UK treasury sanction's list 118N, according to one embodiment. [0089] The digital wallet balance 314 may be the net amount of funds or items of value stored on a digital wallet user's 102 account, and which is available to the digital wallet user 102 for money and/or value services transactions via the internet based money or value transfer service system 116. The digital wallet default currency 315 may be the currency in which the digital wallet balance 314 and transaction(s) 310 of a particular digital wallet user 102 are reported.

FIG. 3B above is a table view 350B of money and value services transactions by the digital wallet user(s) 102, according to one embodiment.

A number of fields are illustrated in the table view 350B includes a transaction ID 321, a transaction type 322. The details of Digital Wallet User 102 may be a user ID 303A, a user name 304A, a user status 305A, a primary address 306 and its risk status, and the user risk score 312A. The selected beneficiary 110A-S may be a user ID 303B, a user name 304B, a user status 305B, a primary address 306B and its risk status 307B and the user risk score 312B. The transaction details 330 may be a transaction limit (transaction limitation 332), an amount to be transacted (transaction amount ($) 335), a payment for the transaction (transaction fees ($) 338), the total sum of the transaction amount (transaction total ($) 340), code of currency to be paid (sending currency 344), code of currency to be received (receiving currency 345), a payout detail(s) 346, a beneficiary receive(s) 347, any comments related to the transaction (transaction comment(s) 348), a transaction risk score (Transaction Risk Score 349), an authorized status (Authorized? 355), a time & date of the transaction (time & date 356), according to one embodiment.

The transaction ID 321 may be a unique identification assigned to a transaction by the internet based money or value transfer service server 100, according to one embodiment. The transaction type 322 may be a description of the type of transaction, based on the purpose of the transaction, according to one embodiment. The digital wallet user ID (user ID 303A) may include a unique identifier that is associated to digital wallet user's 102 accounts and used for identification purposes, according to one embodiment. The user name 304A of the digital wallet user 102 may be the legal names of the digital wallet user(s) 102, according to one embodiment. The digital wallet, user status 305A may identify if a digital wallet user 102 is in an active state where they can engage in a transaction—or in a non-active state where they cannot engage in a transaction unless the transaction is conducted by a customer care agent 224 of the internet based money or value transfer service system 116, according to one embodiment.

The primary address 306 of the digital wallet user 102 may be the main legal address of a digital wallet user 102, with the country's rating 306A, e.g., Basel AML Index score, being the score assigned to the country (associated with the primary address) in the Basel Institute AML Index. The digital wallet user risk score (User Risk Score 312) may be a risk score of a digital wallet user 102, which is calculated based on the digital wallet user's 102 KYC information 216, the user's biometric information (at least one of a fingerprint, a voice print, and/or an iris scan), the user's social media profile 218, (if applicable) the risk scores of the digital wallet user's beneficiaries, the country of birth of the digital wallet user 102, whether the digital wallet user 102 is on a restricted list 118 or person in public life list, meta-data 210, and/or a background check factor 308, and/or the country listed in the primary address 306 of the digital wallet user 102, whereby the country's rating is checked, as well as to see if it is on any type of restricted list 118—E.g. a UK treasury sanction's list 118N, according to one embodiment.

The selected beneficiary 110A-S, user ID 303B may include a unique identifier that is tied to a selected beneficiary 110A-S and used for identification purposes. The user name 304B of the selected beneficiary 110A-S may be the legal names of the selected beneficiary's 110A-S. The selected beneficiary 110A-S Status may identify if a selected beneficiary 110A-S is in an active state where they can engage in a transaction or in a non-active state where they cannot engage in a transaction unless the transaction is conducted by a customer care agent 224 of the internet based money or value transfer service system 116. The primary address 306B of selected beneficiary 110A-S may be the main legal address of a selected beneficiary 110A-S, with the selected beneficiary 110A-S country rating, e.g., Basel AML Index score, being the score assigned to the country (associated with the primary address 306B) in the Basel Institute AML Index, according to one embodiment.

The selected beneficiary 110A-S user risk score (User Risk Score 312) may be a risk score of a digital wallet user 102, which is calculated based on the Selected Beneficiary 110A-S, KYC information 216, the country of birth of the selected beneficiary 110A-S, whether the selected beneficiary 110A-S is on a restricted list 118 or person in public life list, meta-data 210, and/or a background check factor 308, and/or the country listed in the primary address 306 of the selected beneficiary 110A-S, whereby the country's rating, e.g., Basel AML Index score 306A is checked, as well as to see if it is on any type of restricted list 118—e.g. a UK treasury sanction's list 118N. The transaction limitation 332 may include a limit and/or condition placed on a transaction ID 321 by the internet based money or value transfer service server 100. The transaction amount ($) 335 may be the amount of funds or the items of value being transacted by the digital wallet user 102, according to one embodiment.

The transaction fees ($) 338 of the transaction may be the cost to the digital wallet user 102 to conduct a specific transaction, which may include fees to utilize the internet based money or value transfer service system 116, associated taxes and other government fees, and (if applicable) third party fees—e.g. payout center fees. The transaction total 340 may be the sum of the transaction amount ($) 335 and the transaction fees ($) 338. The sending currency 344 of the transaction may be the International Organization for Standardization (ISO) 4217 code for the currency that the transaction is being initiated in. The receiving currency 345 of the transaction may be the ISO 4217 code for the currency that the transaction is requested to be concluded in. The payout details 346 may be the format selected by a digital wallet user 102 for the settlement of the particular transaction. The beneficiary receives 347 may be the amount of funds or other items of value in the receiving currency 345 that the selected beneficiary 110A-S will receive. The transaction comments 348 may be a (an optional) message that a digital wallet user 102 can send to a selected beneficiary 110A-S as part of a transaction, according to one embodiment.

The transaction risk score (Transaction Risk Score 349) may be calculated by analyzing the digital wallet user's risk score and KYC information 216, and/or (if applicable) the risk score of the selected beneficiary 110A-S, the starting and ending locations of the transaction (e.g., the locations of the digital wallet user 102 and the selected beneficiary 110A-S), the time and date 356 of the transaction, checking the country of birth of the digital wallet user 102 and if the digital wallet user 102 and (if applicable) the selected beneficiary 110A-S are on a restricted list 118 or person in public life list, meta-data 210, and/or a background check factor 308, and/or the countries listed in the primary addresses 306 of both the digital wallet user 102 and the selected beneficiary 110A-S whereby the countries' rating, e.g., Basel AML Index scores are checked, as well as to see if they are on any type of restricted list 118—e.g. a UK treasury sanction's list 118N, and/or (if necessary) the procedure by and format in which the funds or items of value are to be received, according to one embodiment.

The authorized? 355 may be the status of a request to perform a transaction on behalf of a digital wallet user 102 and automatically assigned by the internet based money or value transfer service server 100 based on the potential transaction risk score (Transaction Risk Score 349). The time & date 356 may be the actual time and date 356 when the transaction is submitted for processing by the digital wallet user 102 to the internet based money or value transfer service server 100. Particularly, FIG. 3B illustrates the following different transactions:

The first transaction (Transaction ID 321 123) is between digital wallet user 102, user name 304A “Mr. John Toussaint”, (User ID 303A 123-456-789) of primary address 306 9876 Wilshire Boulevard, Beverly Hills, Calif. 90210, United States; and selected beneficiary 110A-S, user name 304B “Claire Toussaint” (User ID 303B 456-123-789)—his mother—of primary address 306B 50 Angle Louverture & Geffrard, Port-au-Prince, HT6110, Haiti—who also happens to be a digital wallet user 102. It is a “Remittance” transaction as identified in the transaction type 322 field. Both users' statuses are set to “Active”, which mean that provided the individual transaction risk score is deemed acceptable, they are allowed to utilize the internet based money or value transfer service system 116 to conduct the transaction. The country risk status for the countries listed in the primary addresses of both John and Claire are considered to be acceptable—i.e. the USA is of low risk with Haiti having a medium risk status. Individually John has a high user risk score—(User Risk Score 312)—(i.e. 85), which based on the how risk scores are assigned, mean that he is considered by the internet based money or value transfer service server 100 to be of low actual risk. On the other hand, John's mother Claire has a risk score of 65, which mean that she is considered of higher actual risk than John by the internet based money or value transfer service server 100, but still within the acceptable range to be allowed to utilize the internet based money or value transfer service system 116. As John and Claire have good backgrounds as observed from their criminal record(s) 308A (both have no criminal records), commercial record(s) 308B (both have good commercial records), and/or the financial record(s) 308C (both have good financial records), the transaction limitation 332 for this particular transaction, as set by the internet based money or value transfer service server 100 is that the transaction limitation 332 cannot exceed US$500—primarily due to John's inclusion in a Person in public Life list 118B. The transaction amount 335 of funds to be remitted is US$250 with the transaction Fees 338 of US$20 thereby bring the transaction total 340 to US$270. The sending currency 344 is USD (i.e. US Dollar), which is based on John's, digital wallet default currency 315, while the receiving currency 345 is HTG (i.e. Haitian Gourde), which is based on the available payout currencies for the transaction type 322 along with the payout details 346. The internet based money or value transfer service server 100 may allow any number of authorized and available payout center(s) 114 to bid on and fulfill the transaction to the selected beneficiary 110A-S—i.e. Claire. Based on the key variables, the internet based money or value transfer service server 100 rates the transaction risk score (Transaction Risk Score 349) for this particular transaction at “Medium” risk, and allows the transaction to proceed with “Yes” to Authorized? 355. In this case, the beneficiary receives 347—i.e. Claire—a total of 11,692.50 HTG, which is based on the selected, receiving currency 345, and is paid out in cash to Claire by a SwiftRemit office (an authorized Payout Center 114) in Haiti, according to the payout details 346. Along with the funds, Claire receives the transaction comments 348 “Happy Mother's Day” from her son John, according to one embodiment.

The second transaction (Transaction ID 321 124) is between user name 304A “Mr. John Toussaint” and selected beneficiary 110A-S user name 304B “Ms. Aditi Tolani” (User ID 303B 123-456-789/B001) of primary address 306B Sahar Airport Road, Chhatrapati Shivaji International Airport Area, Andheri East, Mumbai, Maharashtra, India. It is a “Remittance” transaction as identified in the Transaction Type 322 field. Both users' statuses are set to “Active”, allowing the transaction to proceed provided that the transaction risk score is deemed acceptable. The country risk status of the country listed in Aditi's Primary Address—i.e. India—is considered to be of low risk. With a user risk score—(User Risk Score 312)—of 70, is considered to be of low risk by the internet based money or value transfer service server 100. As John and Aditi have good backgrounds as observed from their criminal record(s) 308A (both have no criminal records), commercial record(s) 308B (both have good commercial records), and/or the financial record(s) 308C (both have good financial records), the transaction limitation 332, set by the internet based money or value transfer service server 100 on this particular transaction is that the transaction limitation 332 cannot exceed US$750—primarily due to John's inclusion in a Persons in Public Life list 118B, but higher than the transaction limitation 332 in the first transaction between John and Claire, as Aditi with a higher User Risk Score 312 than Claire is considered lower risk, thereby allowing this particular transaction to have a higher cap. The transaction amount 335 of funds to be remitted is US$500 with the transaction fees 338 of US$25 thereby bring the transaction Total 340 to US$525. As John is a USA based, digital wallet user 102, the sending currency 344 is USD (i.e. US Dollar), while the receiving currency 345 for Aditi in India is INR (i.e. Indian Rupee). After calculating the key variables, the internet based money or value transfer service server 100 rates the transaction risk score (Transaction Risk Score 349) for this particular transaction at “Medium” risk, and allows the transaction to proceed with “Yes” to authorize? 355. The internet based money or value transfer service server 100 may allow any number of authorized and available payout center(s) 114 to bid on and fulfill the transaction to the selected beneficiary 110A-S—i.e. Aditi. Based on the currency exchanged rate, the Beneficiary Receives 347—i.e. Aditi—31,635 INR, which is paid out to her in cash by the Mumbai Post Office (an authorized Payout Center 114), according to the Payout Details 346, according to one embodiment.

The third transaction (Transaction ID 321 125) is between user name 304A “Mr. John Toussaint” and selected beneficiary 110A-S, user name 304B “Mr. Sudhir Naik” (User ID 303B 123-456-789/B002) of primary address 306B 145 Richmond Street West, Toronto, ON, Canada. It is also a “Remittance” transaction. John's, user status 305A is set to “Active”, but Sudhir's, user status 305B is set to “Non-Active”, which mean that even though the individual transaction risk score needs to be deemed acceptable for the transaction to be allowed to proceed by the internet based money or value transfer service server 100, the transaction in this case, still cannot be processed unless and until a Customer Care Agent 224 changes Sudhir's, User Status 305B from “Non-Active” to “Active”. Despite the country risk status of the country listed in Sudhir's primary addresses—i.e. Canada—being considered low risk and Sudhir himself having a User Risk Score of 75, thereby making him low risk, no transaction involving Sudhir as the selected beneficiary 110A-S by John as the digital wallet user 102 will be allowed to proceed—as Sudhir is not included in John's list of “Active” beneficiaries. Due to Sudhir not being included in John's list of “Active” beneficiaries, the transaction limitation 332 for this particular as set by the internet based money or value transfer service server 100 is set to “Restricted unless/until Customer Care removes ‘Non-Active’ status from Beneficiary”. As a result, the internet based money or value transfer service server 100 further rates the transaction risk score (Transaction Risk Score 349) for this particular transaction at “High” risk, and blocks the processing of the transaction with “No” to Authorized? 355, thereby restricting any payout center(s) 114 from processing this transaction, according to one embodiment.

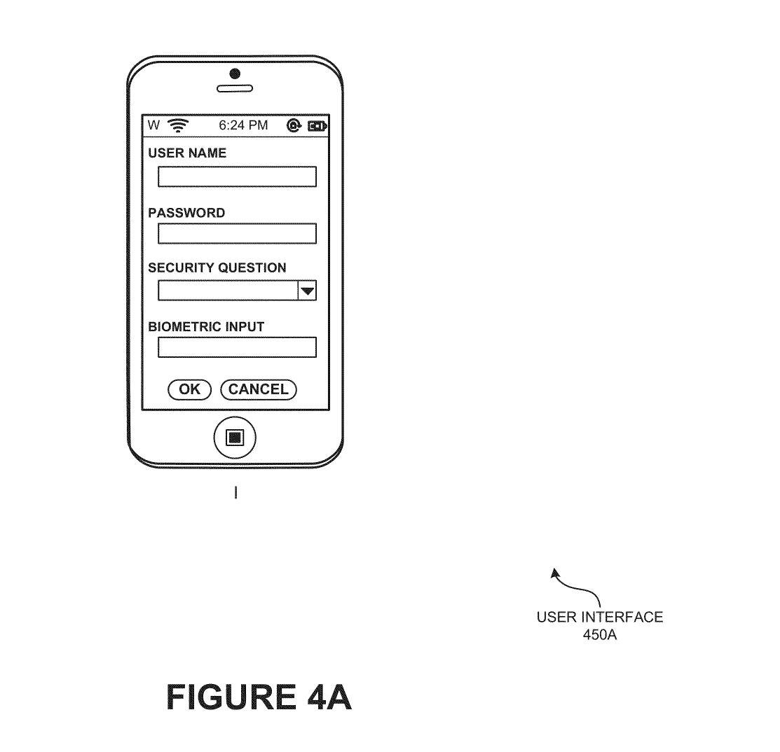

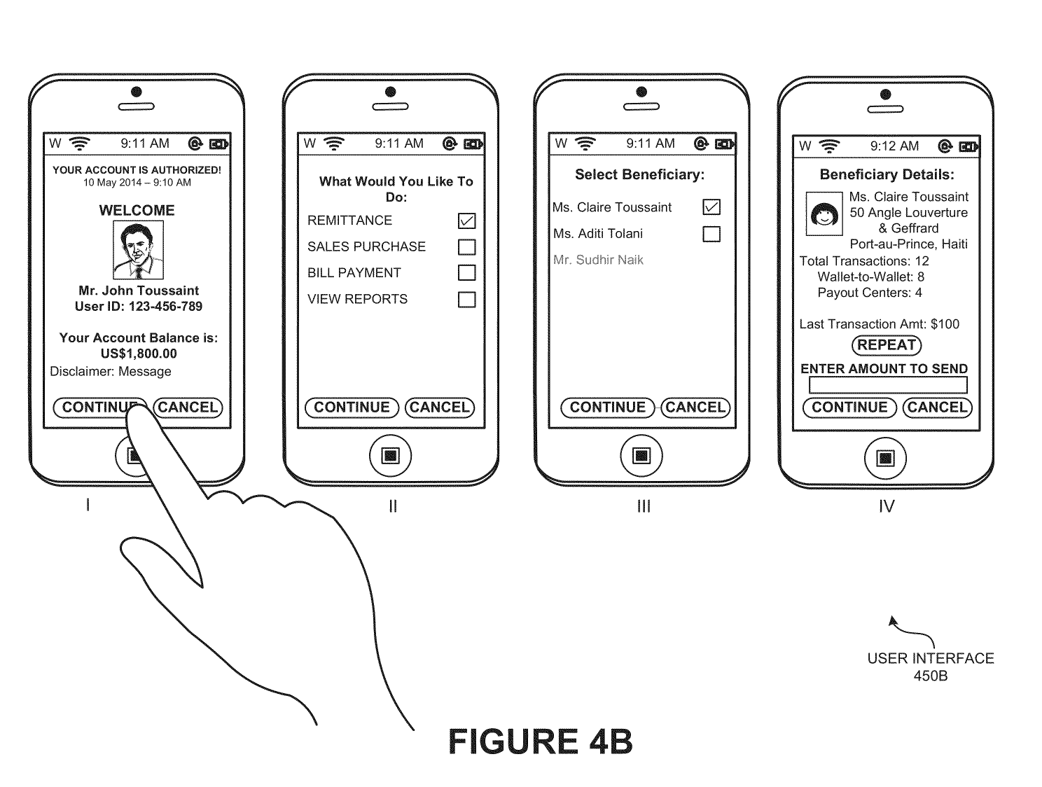

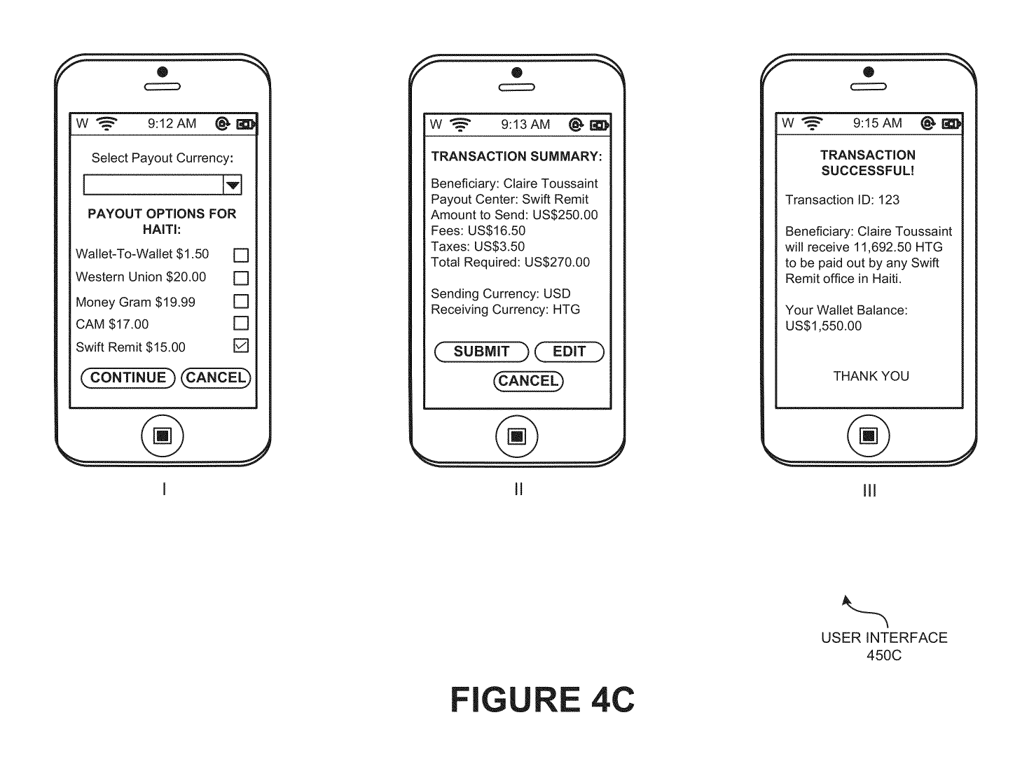

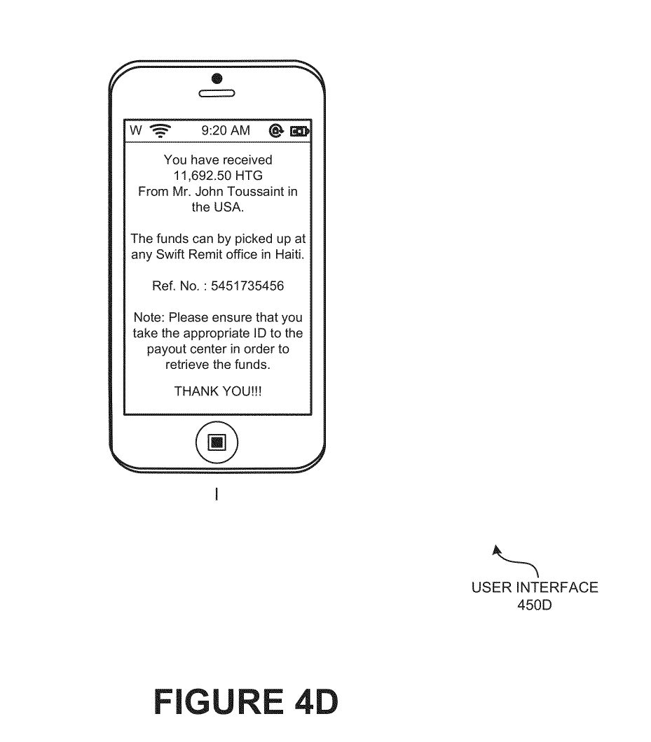

FIG. 4A is a user interface view 450A displaying the login screen to the internet based money or value transfer service server 100, according to one embodiment. In user interface 450AI, the digital wallet user 102 may be presented with the sign-in screen with input fields for a user name, a password, a security question and/or biometric data—e.g. a fingerprint, a voice print, and/or an iris scan, according to one embodiment.

FIG. 4B is a user interface view 450B displaying various stages while completing the transaction to the selected beneficiary 110A-S of FIG. 1, according to one embodiment.

The user interface 450BI, may present the digital wallet user 102 with a “Welcome Screen” displaying the date and time, the digital wallet user's 102 name, the digital wallet user's 102 account number, the digital wallet user's 102 account balance, a disclaimer message, along with buttons to “Continue” or “Cancel” the operation, according to one embodiment. In user interface 450BII, the digital wallet user 102 may be presented with a list of menu options (e.g. review reports, sales purchase, bill payment, remittance) along with buttons to “Ok” or “Cancel” the operation, according to one embodiment.

The user interface 450BIII, may present the digital wallet user 102 with a list of the user's pre-approved beneficiaries 110 of FIG. 1—with the active beneficiaries 110A being selectable and the non-active beneficiaries being grayed out, along with buttons to “Continue” or “Cancel” the operation, according to one embodiment. The number of active beneficiaries 110A in user interface D is pre-determined by the internet based money or value transfer service system 116 based on the digital wallet user's 102 assigned risk score, according to one embodiment.

In user interface 450BIV, the digital wallet user 102 may be presented with the personal details of the selected beneficiary 110A-S of FIG. 1—selected in user interface D—(e.g. photo of the selected beneficiary 110A-S of FIG. 1, the selected beneficiary's 110A-S of FIG. 1 contact/address details, etc.), along with the total number of financial transactions made to the selected beneficiary 110A-S of FIG. 1 via the internet based money or value transfer service system 116, broken out by wallet-to-wallet (e.g., from digital wallet user 102 to digital wallet user 102) and payout centers, the last transaction amount to the selected beneficiary 110A-S, a button to automatically “repeat” the last transaction to the selected beneficiary 110A-S, a field to enter in the dollar amount of the transaction, and buttons to “Continue” or “Cancel” the operation, according to one embodiment. The maximum dollar amount allowed to be transacted by the digital wallet user 102 in user interface 450BIV is determined by the internet based money or value transfer service system 116 based on the period, and/or the Transaction Risk Score 349, and/or the digital wallet user's 102 risk score and/or (if applicable) the risk score of the selected beneficiary 110A-S and/or the rating, e.g., Basel AML Index scores, of the countries in the primary addresses 306 of the selected beneficiary 110A-S and the digital wallet user 102, according to one embodiment.

FIG. 4C is a user interface view 450C displaying various stages while completing the transaction to the selected beneficiary 110A-S of FIG. 1, according to one embodiment. In user interface 450CI, may display the available payout currencies and the payout options (e.g. wallet-to-wallet, payout center(s) 114) to send the funds to the selected beneficiary 110A-S of FIG. 1, along with the cost of each option, as determined by the Internet Based Money or Value Transfer Service server 100, and buttons to “Continue” or “Cancel” the operation, according to one embodiment. The available payout currencies and payout options listed in user interface 450CI are determined automatically by the internet based money or value transfer service system 116 based on the location of the selected beneficiary 110A-S of FIG. 1, according to one embodiment.

In user interface 450CII, the internet based money or value transfer service server 100 may calculate the “Total Required Funds”, e.g., a “Sending Amount” plus the applicable charges (e.g. Payout Center fees, government tax, service charges, etc.) to complete the transaction, according to one embodiment. The internet based money or value transfer service system 116, presents a summary of the transaction to the digital wallet user 102 in user interface G, along with buttons to either “Submit”, “Edit”, or “Cancel” the transaction, according to one embodiment. The applicable charges (e.g. Payout Center fees, government tax, service charges, etc.) in user interface G, is automatically calculated by the internet based money or value transfer service server 100 based on the primary address country rating, e.g., Basel AML Index score, 306A of the digital wallet user 102, and (if applicable) the terms and conditions of the third party payout center(s) 114, according to one embodiment. In user interface 450CIII, the internet based money or value transfer service server 100 may present the digital wallet user 102 with a “Transaction Successful” confirmation message along with the transaction's details—e.g. the transaction ID, the transaction amount in the receiving currency, the selected beneficiary 110A-S of FIG. 1 name, (if applicable) the name of the payout center(s) 114, and the updated account balance of the digital wallet user's 102 account, according to one embodiment.

FIG. 4D is a user interface view 450D displaying a message sent by the internet based money or value transfer service server 100 to the internet device of the selected beneficiary 110A-S. The user interface 450DI may show the notification sent by the internet based money or value transfer service server 100 regarding the status of the transaction to the selected beneficiary 110A-S, according to one embodiment.

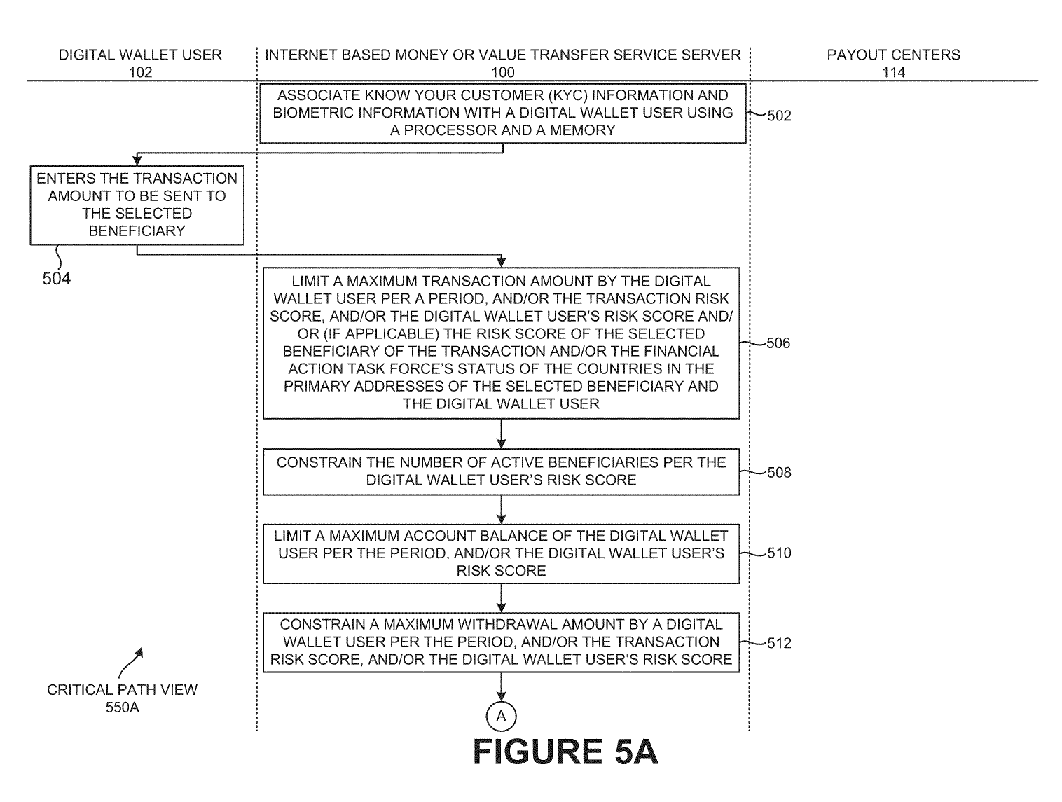

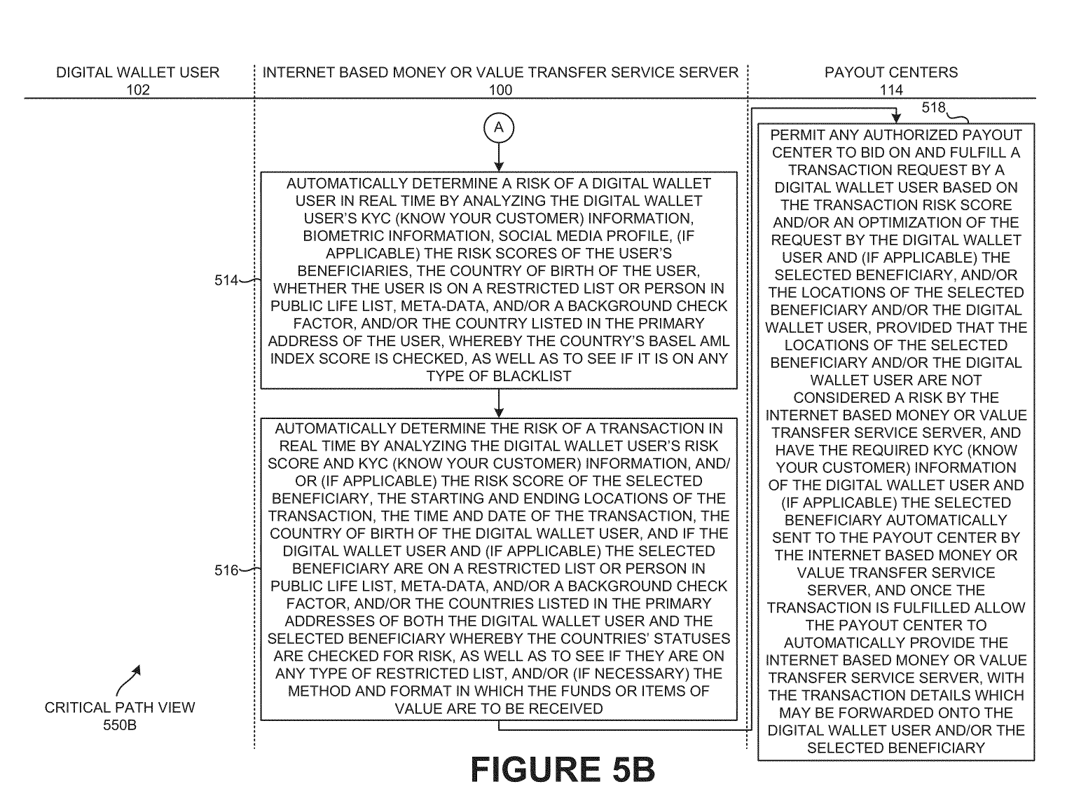

FIG. 5 is a critical path view 550 for allowing any authorized payout center 114 to bid on and fulfill a money services request by a digital wallet user 102 based on the Transaction Risk Score 349 and/or an optimization of the request by the digital wallet user 102 and (if applicable) the selected beneficiary 110A-S, and/or the locations of the selected beneficiary 110A-S and/or the digital wallet user 102, provided that the locations of the selected beneficiary 110A-S and/or the digital wallet user 102 are not considered a risk by the internet based money or value transfer service server 100, and have the required, KYC information 216 of the digital wallet user 102 and (if applicable) the selected beneficiary 110A-S automatically sent to the payout center by the internet based money or value transfer service server 100, and once the transaction is fulfilled allow the payout center to automatically provide the internet based money or value transfer service server 100 with the transaction details which may be forwarded onto the digital wallet user 102 and/or the selected beneficiary 110A-S, according to one embodiment.

In operation 502, the internet based money or value transfer service server 100 may associate a digital wallet user 102 with the user's, KYC information 216 (based on the Financial Action Task Force requirements) and the user's 102 biometric information, using a processor 106 and a memory 108, according to one embodiment. In operation 504, the digital wallet user 102 may enter the transaction amount to be sent to the selected beneficiary 110A-S, according to one embodiment. In operation 506, the internet based money or value transfer service server 100 may limit the financial transaction amount by a digital wallet user 102 per a period, and/or the Transaction Risk Score 349, and/or the digital wallet user's 102 risk score and/or (if applicable) the risk score of the selected beneficiary 110A-S of the transaction and/or the country rating, e.g., Basel AML Index scores, of the countries in the primary addresses 306 of the selected beneficiary 110A-S and the digital wallet user 102, according to one embodiment.

In operation 508, the internet based money or value transfer service server 100 may constrain the number of active beneficiaries 110A—e.g. remittee—by a digital wallet user 102 per the risk score of the digital wallet user 102, according to one embodiment. In operation 510, the internet based money or value transfer service server 100 may limit the account balance of the digital wallet user 102 per the period and/or the digital wallet user's 102 risk score, according to one embodiment. In operation 512, the internet based money or value transfer service server 100 may constrain the withdrawal amount per the period, and/or based on theTransaction Risk Score, and/or the digital wallet user's risk score, according to one embodiment. [0113] In operation 514, the internet based money or value transfer Service server 100 may automatically determine the User Risk Score 312 in real time by analyzing the user's verified personal information, such as KYC information 216, the user's biometric information (at least one of a fingerprint, a voice print, and/or an iris scan), the user's social media profile 218, (if applicable) the risk scores of the user's beneficiaries, the country of birth 309 of the user 102, whether the user 102 is on a restricted list 118 or person in public life list, meta-data 210, and/or a background check factor 308, and/or the country listed in the primary address 306 of the user 102, whereby the country's rating, e.g., Basel AML Index score, 306A is checked, as well as to see if it is on any type of restricted list 118, e.g. a UK Treasury sanction's list, 118N, according to one embodiment.

In operation 516, the internet based money or value transfer service server 100 may automatically determine the Transaction Risk Score 349 in real time by analyzing the digital wallet user's risk score and verified personal information such as KYC information 216, and/or (if applicable) the risk score of the selected beneficiary 110A-S, the starting and ending locations of the transaction (e.g., the locations of the digital wallet user 102 and the selected beneficiary 110A-S), the time and date 356 of the transaction, checking the country of birth of the digital wallet user 102 and if the digital wallet user 102 and (if applicable) the selected beneficiary 110A-S are on a restricted list 118 210, and/or a background check factor 308, and/or the countries listed in the primary addresses 306 of both the digital wallet user 102 and the selected beneficiary 110A-S whereby the countries' rating, e.g., Basel AML Index scores, are checked, as well as to see if they are on any type of restricted list 118—e.g. a UK treasury sanction's list 118N, and/or (if necessary) the procedure by and format in which the funds or items of value are to be received, according to one embodiment.

In operation 518, the payout center(s) 114 may be permitted to bid on and fulfill a money services request by a digital wallet user 102 based on the Transaction Risk Score 349 and/or an optimization of the request by the digital wallet user 102 and (if applicable) the selected beneficiary 110A-S, and/or the locations of the selected beneficiary 110A-S and/or the digital wallet user 102, provided that the locations of the selected beneficiary 110A-S and/or the digital wallet user 102 are not considered a risk by the internet based money or value transfer service server 100, and have the required, KYC information 216 of the digital wallet user 102 and (if applicable) the selected beneficiary 110A-S automatically sent to the payout center by the internet based money or value transfer service server 100, and once the transaction is fulfilled allow the payout center to automatically provide the internet based money or value transfer service server 100 with the transaction details which may be forwarded onto the digital wallet user 102 and/or the selected beneficiary 110A-S, according to one embodiment.

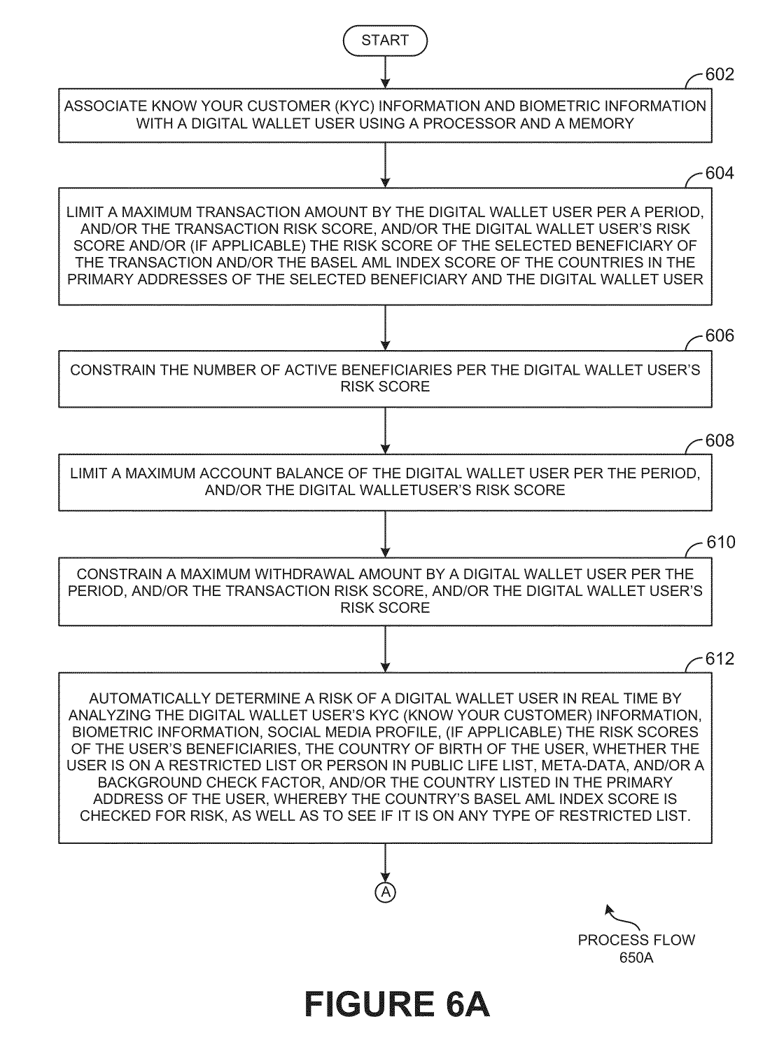

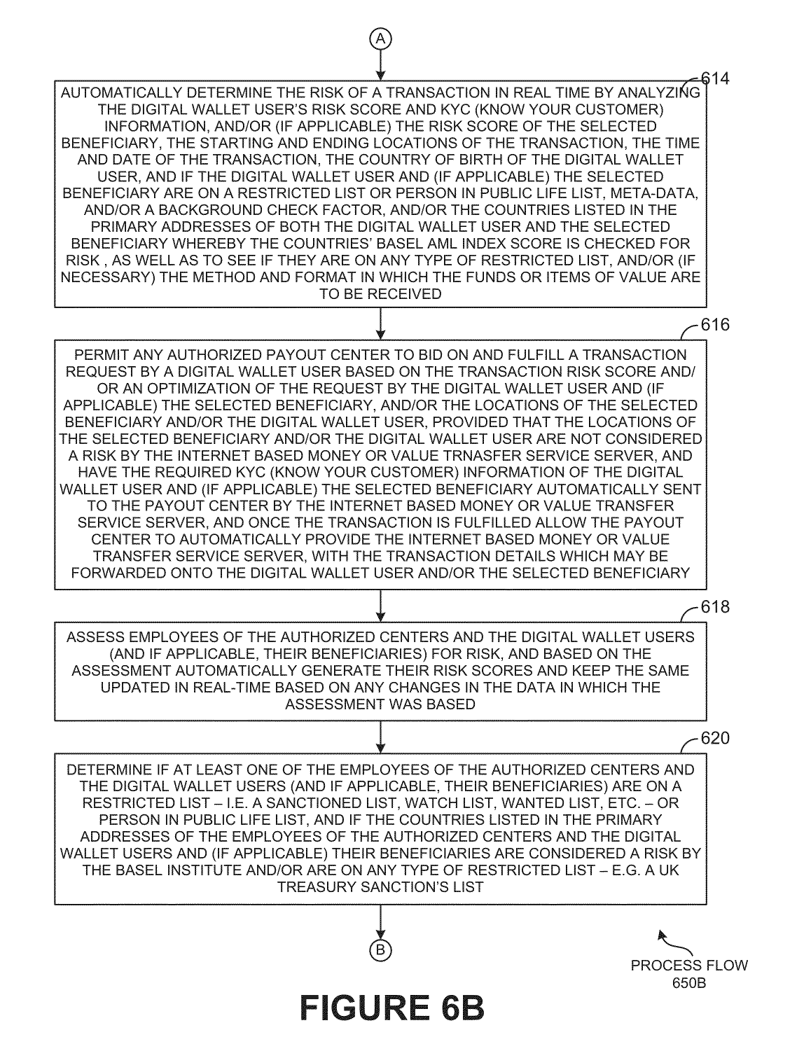

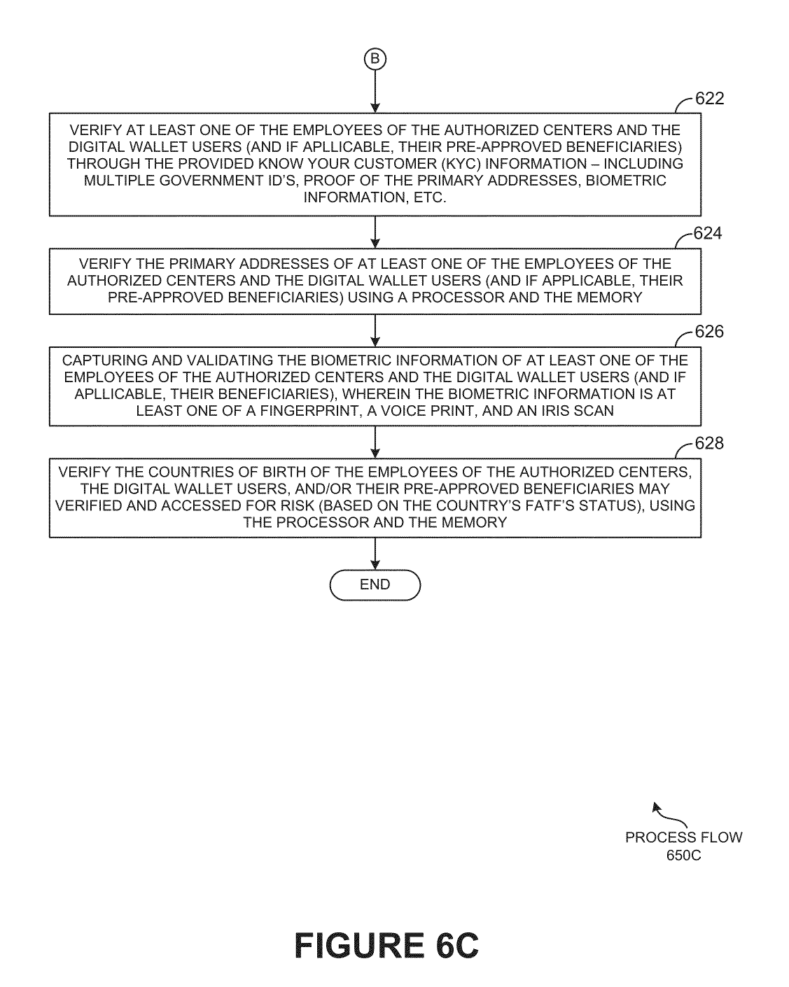

FIG. 6A is a process flow 650 detailing the operations involved in the internet based money or value transfer Service server 100, according to one embodiment.

In operation 602, a digital wallet user 102 may be associated with the user's, KYC information 216 (based on the Financial Action Task Force requirements) and his/her biometric information, using a processor 106 and a memory 108, according to one embodiment. In operation 604, the requested transaction amount by a digital wallet user 102 may be limited per a period, and/or the Transaction Risk Score 349, and/or the digital wallet user's 102 risk score and/or (if applicable) the risk score of the selected beneficiary 110A-S of the transaction and/or the country rating, e.g., Basel AML Index scores, of the countries in the primary addresses 306 of the selected beneficiary 110A-S and the digital wallet user 102, according to one embodiment. In operation 606, the number of active beneficiaries 110A—e.g. remittees—by a digital wallet user 102 may be constrained per the risk score of the digital wallet user 102, according to one embodiment.

In operation 608, the digital wallet balance 314 of the digital wallet user 102 may be limited per the period and/or the digital wallet user's 102 risk score, according to one embodiment. In operation 610, a maximum withdrawal amount is may be imposed per the period and/or based on the Transaction Risk Score 349 and/or the digital wallet user's risk score, according to one embodiment. In operation 612, the User Risk Score 312 is determined in real time by analyzing the user's, KYC information 216, the user's biometric information (at least one of a fingerprint, a voice print, and/or an iris scan), the user's social media profile 218, (if applicable) the risk scores of the user's beneficiaries, the country of birth 309 of the user 102, whether the user 102 is on a restricted list 118 or a person in public life list 118B, meta-data 210, and/or a background check factor 308, and/or the country listed in the primary address 306 of the user 304, whereby the country's rating, e.g., Basel AML Index score, 306A is checked, as well as to see if it is on any type of restricted list 118—e.g. a UK treasury sanction's list 118N, according to one embodiment.

In operation 614, the Transaction Risk Score 349 is determined automatically in real time by analyzing the digital wallet user's risk score and KYC information 216, and/or (if applicable) the risk score of the selected beneficiary 110A-S, the starting and ending locations of the transaction (e.g., the locations of the digital wallet user 102 and the selected beneficiary 110A-S), the time and date 356 of the transaction, checking the country of birth 309 of the digital wallet user 102 and if the digital wallet user 102 and (if applicable) the selected beneficiary 110A-S are on a restricted list 118, meta-data 210, and/or a background check factor 308, and/or the countries listed in the primary addresses 306 of both the digital wallet user 102 and the selected beneficiary 110A-S whereby the countries' rating, e.g., Basel AML Index scores, are checked, as well as to see if they are on any type of restricted list 118—e.g. a UK treasury sanction's list 118N, and/or (if necessary) the procedure by and format in which the funds or items of value are to be received, according to one embodiment.

In operation 616, any number of authorized payout center(s) 114 may be permitted to bid on and fulfill a money services request by a digital wallet user 102 based on the Transaction Risk Score 349 and/or an optimization of the request by the digital wallet user 102 and (if applicable) the selected beneficiary 110A-S, and/or the locations of the selected beneficiary 110A-S and/or the digital wallet user 102, provided that the locations of the selected beneficiary 110A-S and/or the digital wallet user 102 are not considered a risk by the internet based money or value transfer service server 100, and have the required verified personal information, such as KYC information 216 of the digital wallet user 102 and (if applicable) the selected beneficiary 110A-S automatically sent to the payout center by the internet based money or value transfer service server 100, and once the transaction is fulfilled allow the payout center(s) 114 to automatically provide the internet based money or value transfer service server 100 with the transaction details which may be forwarded onto the digital wallet user 102 and/or the selected beneficiary 110A-S, according to one embodiment.

FIG. 6B is a continuation of process flow 651 of FIG. 6A showing additional processes, according to one embodiment. In operation 618, employees of the authorized center(s) 222, digital wallet user(s) 102, and their pre-approved beneficiaries 110 may be assessed for risk, and based on the assessment automatically generate their User Risk Score 312 and keep the same updated in real-time based on any changes in the data in which the assessment was based. In operation 620, the internet based money or value transfer service server 100 may determine (e.g. using authorization module 228) if the employees of the authorized center(s) 222 and the digital wallet user(s) 102 (and if applicable, their pre-approved beneficiaries 110) are on a restricted list 118, and if the countries listed in the primary addresses 306 of the employees of the authorized center(s) 222 and the digital wallet user(s) 102 and (if applicable) their beneficiaries are considered a risk by a rating oranization, such as the FATF, the Basel Institute, or other organization, and/or are on any type of restricted list 118—e.g. a UK treasury sanction's list 118N, according to one embodiment.

In operation 622, the employees of the authorized center(s) 222 and the digital wallet user(s) 102 (and if applicable, their beneficiaries) may be verified (e.g. using verification module 230) through the provided verified personal information (such as KYC information) 216—including multiple Government ID's, proof of the provided primary addresses 306, biometric information, etc., according to one embodiment. In operation 624, the primary addresses 306 of the employees of the authorized center(s) 222, the digital wallet user(s) 102, and/or their pre-approved beneficiaries 110 may be verified. In operation 626, biometric information of the employees of the authorized center(s) 222, the digital wallet user(s) 102, and/or their pre-approved beneficiaries 110 may be validated (e.g. using verification module 230). In operation 628, the countries of birth of the employees of the authorized center(s) 222, the digital wallet user(s) 102, and/or their pre-approved beneficiaries 110 may verified (e.g. using verification module 230) and accessed for risk (e.g., based on the country's Basel AML Index score), according to one embodiment.

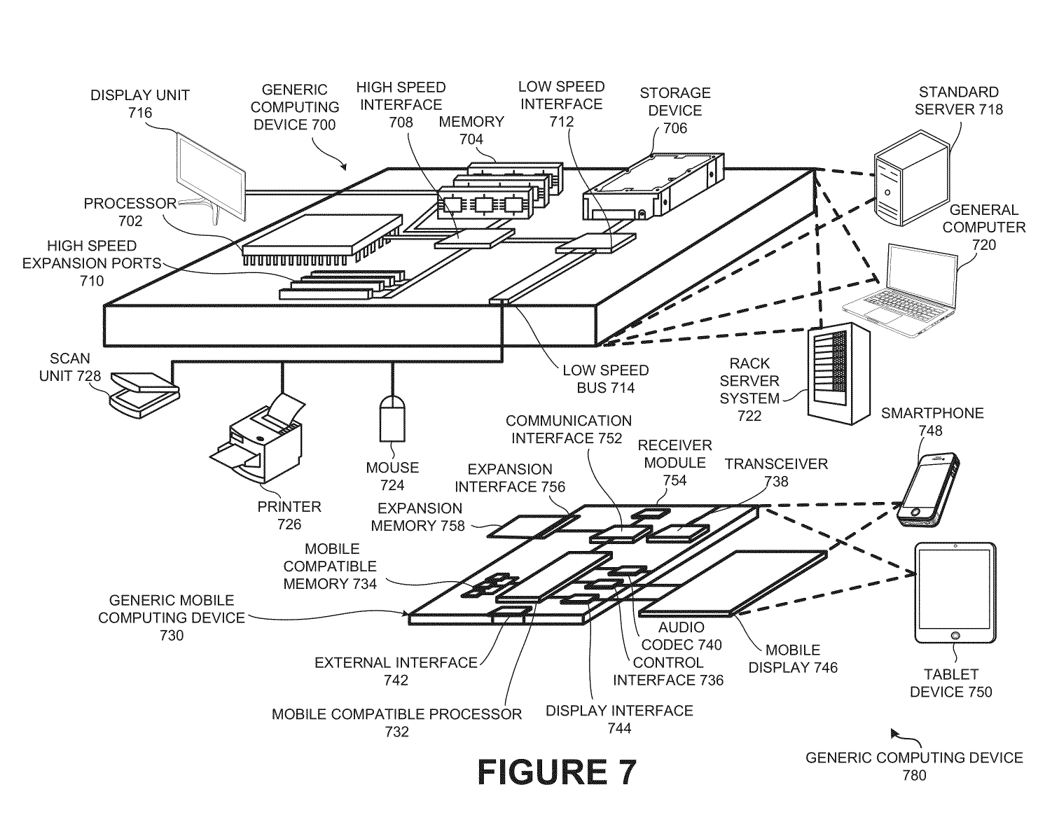

FIG. 7 is a schematic diagram 780 of computing device 700 that can be used to implement the methods and systems disclosed herein, according to one or more embodiments. FIG. 7 is a schematic diagram 780 of a computing device 700 and a generating mobile computing device 730 that can be used to perform and/or implement any of the embodiments disclosed herein. In one or more embodiments, the Internet Based Money or Value Transfer Service server 100 and/or Internet device 105 of FIG. 1 may be the computing device 700, according to one embodiment.

The computing device 700 may represent various forms of digital computers, such as laptops, desktops, workstations, personal digital assistants, servers, blade servers, mainframes, and/or other appropriate computers. The generating mobile computing device 730 may represent various forms of mobile devices, such as smartphones, camera phones, personal digital assistants, cellular telephones, and other similar mobile devices. The components shown here, their connections, couples, and relationships, and their modules, are meant to be exemplary only, and are not meant to limit the embodiments described and/or claimed, according to one embodiment.

The computing device 700 may include a processor 702, a memory 704, a storage device 706, a high speed interface 708 coupled to the memory 704 and a plurality of high speed expansion ports 710, and a low speed interface 712 coupled to a low speed bus 714 and a storage device 706. In one embodiment, each of the components heretofore may be inter-coupled using various buses, and may be mounted on a common motherboard and/or in other manners as appropriate. The processor 702 may process instructions for execution in the computing device 700, including instructions stored in the memory 704 and/or on the storage device 706 to display a graphical information for a GUI on an external input/output device, such as a display unit 716 coupled to the high speed interface 708, according to one embodiment.

In other embodiments, multiple processors and/or multiple buses may be used, as appropriate, along with multiple memories and/or types of memory. Also, a plurality of computing device 700 may be coupled with, with each device providing portions of the necessary operations (e.g. as a server bank, a group of blade servers, and/or a multi-processor system), according to one embodiment.

The memory 704 may be coupled to the computing device 700. In one embodiment, the memory 704 may be a volatile memory. In another embodiment, the memory 704 may be a non-volatile memory. The memory 704 may also be another form of computer-readable medium, such as a magnetic and/or an optical disk. The storage device 706 may be capable of providing mass storage for the computing device 700. In one embodiment, the storage device 706 may be included of a floppy disk device, a hard disk device, an optical disk device, a tape device, a flash memory and/or other similar solid state memory device. In another embodiment, the storage device 706 may be an array of the devices in a computer-readable medium previously mentioned heretofore, computer-readable medium, such as, and/or an array of devices, including devices in a storage area network and/or other configurations, according to one embodiment.

A computer program may be included of instructions that, when executed, perform one or more methods, such as those described above. The instructions may be stored in the memory 704, the storage device 706, a memory coupled to the processor 702, and/or a propagated signal.

The high speed interface 708 may manage bandwidth-intensive operations for the computing device 700, while the low speed interface 712 may manage lower bandwidth-intensive operations. Such allocation of functions is exemplary only. In one embodiment, the high speed interface 708 may be coupled to the memory 704, the display unit 716 (e.g. through a graphics processor and/or an accelerator), and to the plurality of high speed expansion ports 710, which may accept various expansion cards, according to one embodiment.

In the embodiment, the low speed interface 712 may be coupled to the storage device 706 and the low speed bus 714. The low speed bus 714 may be included of a wired and/or wireless communication port (e.g. a Universal Serial Bus (“USB”), a Bluetooth® port, an Ethernet port, and/or a wireless Ethernet port). The low speed bus 714 may also be coupled to scan unit 728, a printer 726, a keyboard, a mouse 724, and a networking device (e.g. a switch and/or a router) through a network adapter, according to one embodiment.

The computing device 700 may be implemented in a number of different forms, as shown in the figure. In one embodiment, the computing device 700 may be implemented as a server 718 and/or a group of such servers. In another embodiment, the computing device 700 may be implemented as part of a rack server system 722. In yet another embodiment, the computing device 700 may be implemented as a computer 720 such as a laptop and/or desktop computer. Alternatively, a component from the computing device 700 may be combined with another component in a generating mobile computing device 730. In one or more embodiments, an entire system may be made up of a plurality of computing device 700 and/or a plurality of computing device 700 coupled to a plurality of generating mobile computing device 730, according to one embodiment.

In one embodiment, the generating mobile computing device 730 may include a mobile compatible processor 732, a mobile compatible memory 734, and an input/output device such as a mobile display 746, a communication interface 752, and a transceiver 738, among other components. The generating mobile computing device 730 may also be provided with a storage device, such as a Microdrive and/or other device, to provide additional storage. In one embodiment, the components indicated heretofore are inter-coupled using various buses, and several of the components may be mounted on a common motherboard, according to one embodiment.

The mobile compatible processor 732 may execute instructions in the generating mobile computing device 730, including instructions stored in the mobile compatible memory 734. The mobile compatible processor 732 may be implemented as a chipset of chips that include separate and multiple analog and digital processors. The mobile compatible processor 732 may provide, for example, for coordination of the other components of the generating mobile computing device 730, such as control of user interfaces, applications run by the generating mobile computing device 730, and wireless communication by the generating mobile computing device 730, according to one embodiment.

The mobile compatible processor 732 may communicate with a user through the control interface 736 and the display interface 744 coupled to a mobile display 746. In one embodiment, the mobile display 746 may be a Thin-Film-Transistor Liquid Crystal Display (“TFT LCD”), an Organic Light Emitting Diode (“OLED”) display, and another appropriate display technology. The display interface 744 may include appropriate circuitry for driving the mobile display 746 to present graphical and other information to a user. The control interface 736 may receive commands from a user and convert them for submission to the mobile compatible processor 732.

In addition, an external interface 742 may be provided in communication with the mobile compatible processor 732, so as to enable near area communication of the generating mobile computing device 730 with other devices. External interface 742 may provide, for example, for wired communication in some embodiments, and/or for wireless communication in other embodiments, and multiple interfaces may also be used, according to one embodiment.

The mobile compatible memory 734 may be coupled to the generating mobile computing device 730. The mobile compatible memory 734 may be implemented as a volatile memory and a non-volatile memory. The expansion memory 758 may also be coupled to the generating mobile computing device 730 through the expansion interface 756, which may include, for example, a Single In Line Memory Module (“SIMM”) card interface. The expansion memory 758 may provide extra storage space for the generating mobile computing device 730, and/or may also store an application and/or other information for the generating mobile computing device 730, according to one embodiment.

Specifically, the expansion memory 758 may include instructions to carry out the processes described above. The expansion memory 758 may also include secure information. For example, the expansion memory 758 may be provided as a security module for the generating mobile computing device 730, and may be programmed with instructions that permit secure use of the generating mobile computing device 730. In addition, a secure application may be provided on the SIMM card, along with additional information, such as placing identifying information on the SIMM card in a non-hackable manner, according to one embodiment.

The mobile compatible memory 734 may include a volatile memory (e.g. a flash memory) and a non-volatile memory (e.g. a non-volatile random-access memory (“NVRAM”)). In one embodiment, a computer program includes a set of instructions that, when executed, perform one or more methods. The set of instructions may be stored on the mobile compatible memory 734, the expansion memory 758, a memory coupled to the mobile compatible processor 732, and a propagated signal that may be received, for example, over the transceiver 738 and/or the external interface 742, according to one embodiment.

The generating mobile computing device 730 may communicate wirelessly through the communication interface 752, which may be included of a digital signal processing circuitry. The communication interface 752 may provide for communications using various modes and/or protocols, such as: a Global System for Mobile Communications (“GSM”) protocol, a Short Message Service (“SMS”) protocol, an Enhanced Messaging System (“EMS”) protocol, a Multimedia Messaging Service (“MMS”) protocol, a Code Division Multiple Access (“CDMA”) protocol, Time Division Multiple Access (“TDMA”) protocol, a Personal Digital Cellular (“PDC”) protocol, a Wideband Code Division Multiple Access (“WCDMA”) protocol, a CDMA2000 protocol, and a General Packet Radio Service (“GPRS”) protocol, according to one embodiment.

Such communication may occur, for example, through the transceiver 738 (e.g. radio-frequency transceiver). In addition, short-range communication may occur, such as using a Bluetooth®, Wi-Fi, and/or other such transceiver. In addition, a GPS (“Global Positioning System”) receiver module may provide additional navigation-related and location-related wireless data to the generating mobile computing device 730, which may be used as appropriate by a software application running on the generating mobile computing device 730, according to one embodiment.

The generating mobile computing device 730 may also communicate audibly using an audio codec 740, which may receive spoken information from a user and convert it to usable digital information. The audio codec 740 may likewise generate audible sound for a user, such as through a speaker (e.g. in a handset of the generating mobile computing device 730). Such a sound may include a sound from a voice telephone call, a recorded sound (e.g. a voice message, a music files, etc.) and may also include a sound generated by an application operating on the generating mobile computing device 730, according to one embodiment.

The generating mobile computing device 730 may be implemented in a number of different forms, as shown in the figure. In one embodiment, the generating mobile computing device 730 may be implemented as a smartphone 748. In another embodiment, the generating mobile computing device 730 may be implemented as a personal digital assistant (“PDA”). In yet another embodiment, the generating mobile computing device 730 may be implemented as a tablet device 750, according to one embodiment.

Various embodiments of the systems and techniques described here can be realized in a digital electronic circuitry, an integrated circuitry, a specially designed application specific integrated circuits (“ASICs”), a piece of computer hardware, a firmware, a software application, and a combination thereof. These various embodiments can include embodiment in one or more computer programs that are executable and/or interpretable on a programmable system including programmable processor, which may be special and/or general purpose, coupled to receive data and instructions from, and to transmit data and instructions to, a storage system, input device, and output device, according to one embodiment.

These computer programs (also known as programs, software, software applications, and/or code) include machine-readable instructions for a programmable processor, and can be implemented in a high-level procedural and/or object-oriented programming language, and/or in assembly/machine language. As used herein, the terms “machine-readable medium” and/or “computer-readable medium” refers to any computer program product, apparatus and/or device (e.g. magnetic discs, optical disks, memory, and/or Programmable Logic Devices (“PLDs”)) used to provide machine instructions and/or data to a programmable processor, including a machine-readable medium that receives machine instructions as a machine-readable signal. The term “machine-readable signal” refers to any signal used to provide machine instructions and/or data to a programmable processor, according to one embodiment.

To provide for interaction with a user, the systems and techniques described here may be implemented on a computing device having a display device (e.g. a cathode ray tube (“CRT”) and/or liquid crystal (“LCD”) monitor) for displaying information to the user and a keyboard and a mouse 724 by which the user can provide input to the computer. Other kinds of devices can be used to provide for interaction with a user as well; for example, feedback provided to the user can be any form of sensory feedback (e.g. visual feedback, auditory feedback, and/or tactile feed-back) and input from the user can be received in any form, including acoustic, speech, and/or tactile input.

The systems and techniques described here may be implemented in a computing system that includes a back end component (e.g. as a data server), a middleware component (e.g. an application server), a front end component (e.g. a client computer having a graphical user interface, and/or a Web browser through which a user can interact with an embodiment of the systems and techniques described here), and a combination thereof. The components of the system may also be coupled through a communication network.

The communication network may include a local area network (“LAN”) and a wide area network (“WAN”) (e.g. the Internet). The computing system can include a client and a server. In one embodiment, the client and the server are remote from each other and interact through the communication network.

An example embodiment will now be described. In one example, John Toussaint may be a finance professional working in Beverly Hills, Calif. John may earn enough money to support his impoverished mother in his home country, Haiti. John may use a walk-in Money Service Business near his home to send remittances. The remittance vendor may find it difficult to ensure compliance with a multitude of financial, banking, legal, and Financial Action Task Force requirements in a regulatory sound manner. Also, the Money or Value Transfer Services business may find it difficult to determine with a high degree of certainty if John and/or his mother are using the money-transfer service for illegal purposes.

As such, the Money or Value Transfer Services business may be limited in its ability to manage the risk level associated with the transaction effectively. John may also notice that the Money or Value Transfer Services business, ‘SwiftRemit’ that he selected to conduct the transaction has limited payout outlets in his homeland, Haiti. Further, John may be concerned whether the remittance to be sent is properly delivered to the pre-approved beneficiary, his mother in Haiti.

Thanks to the various embodiments described in FIGS. 1-7. The Internet Based Money or Value Transfer Service server (as described in various embodiments of FIGS. 1-7) may authenticate the Payout Center, John, and his mother based on verifiable government identifications, John's biometric information, John's country of birth, John and his mother primary address, etc. John and (if necessary) his mother may have to register at an authorized center prior to being allowed to utilize the Internet Based Money or Value Transfer Service system (as described in various embodiments of FIGS. 1-7). The Internet Based Money or Value Transfer Service server (as described in various FIGS. 1-7) may inspect the risk level of the transaction between John and his mother. The Internet Based Money or Value Transfer Service server may generate a Transaction Risk Score between John and his mother. The risk score may be low. The Money or Value Transfer Services business may now find it more palatable to provide money transfer services to John, and by extension, his mother. The Internet Based Money or Value Transfer Service server (as described in FIGS. 1-7) may also notify John and/or his mother regarding the status of the transaction that may be of additional benefit to them.

In another example, ‘Mr. Parker Evans’ may have been involved in fraudulent activities in the past. Traditional Money Transfer Services may be suspicious of Parker, but yet find it difficult to investigate his background records. As such, they may by suspicious of offering money transfer services to Parker due to the various embodiments described in FIGS. 1-7. The Internet Based Money or Value Transfer Service server (as described in various embodiments of FIGS. 1-7) may authenticate Parker based on the background check factor (as described in various embodiments of FIGS. 1-7). The Internet Based Money or Value Transfer Service server may check the account and/or risk score of Parker to (if necessary) prohibit him from taking advantage of the Internet Based Money or Value Transfer Service system (as described in various embodiments of FIGS. 1-7), and thereby help Money Services businesses—e.g. Payout Centers—from being fined for providing money transfer services to such a high risk individual.

Although the present embodiments have been described with reference to specific example embodiments, it will be evident that various modifications and changes may be made to these embodiments without departing from the broader spirit and scope of the various embodiments. For example, the various devices and modules described herein may be enabled and operated using hardware circuitry (e.g. CMOS based logic circuitry), firmware, software or any combination of hardware, firmware, and software (e.g. embodied in a non-transitory machine-readable medium). For example, the various electrical structure and methods may be embodied using transistors, logic gates, and electrical circuits (e.g. application specific integrated (ASIC) circuitry and/or Digital Signal Processor (DSP) circuitry). In addition, it will be appreciated that the various operations, processes and methods disclosed herein may be embodied in a non-transitory machine-readable medium and/or a machine-accessible medium compatible with a data processing system (e.g. data processing device). Accordingly, the specification and drawings are to be regarded in an illustrative rather than a restrictive sense.

A number of embodiments have been described. Nevertheless, it will be understood that various modifications may be made without departing from the spirit and scope of the claimed invention. In addition, the logic flows depicted in the figures do not require the particular order shown, and/or sequential order, to achieve desirable results. In addition, other steps may be provided, or steps may be eliminated, from the described flows, and other components may be added to, and/or removed from, the described systems. Accordingly, other embodiments are within the scope of the following claims. It may be appreciated that the various sy stems, methods, and apparatus disclosed herein may be embodied in a machine-readable medium and/or a machine accessible medium compatible with a data processing system (e.g. a computer system), and/or may be performed in any order, according to one embodiment.

The structures and modules in the figures may be shown as distinct and communicating with only a few specific structures and not others. The structures may be merged with each other, may perform overlapping functions, and may communicate with other structures not shown to be connected in the figures. Accordingly, the specification and/or drawings may be regarded in an illustrative rather than a restrictive sense.

The process flows and flow diagrams depicted in the figures do not require the particular order shown, or sequential order, to achieve desirable results. In addition, others may be provided, or steps may be eliminated from the described flows, and other components may be added to or removed from the depictions.

What is claimed is:

1. An internet based money and value transfer service, comprising:
associating a digital wallet user with a user's verified personal information information and the user's biometric information using a processor and a memory;
limiting a requested financial transaction amount by at least one of a digital wallet user per a period, a transaction risk score, the digital wallet user's risk score and a risk score of a selected beneficiary of a transaction and a country rating for a set of countries in a primary addresses of the selected beneficiary and the digital wallet user;
constraining a number of active beneficiaries by a digital wallet user based on, at least in part, the risk score of the digital wallet user;
limiting a wallet balance of the digital wallet user per the period and the digital wallet user's risk score;
constraining a withdrawal amount per the period, based at least in part on a transaction risk score and the digital wallet user's risk score;
automatically determining a user risk score in real time by analyzing at least one of the user's verified personal information, the user's biometric information, the user's social media profile, the risk scores of the user's beneficiaries, the country of birth of the user, whether the user is on a restricted list, a person in public life list, a meta-data, a background check factor, and a country listed in the primary address of the user, whereby the country's rating score is checked, as well as to see if it is on any type of restricted list;
automatically determining the transaction risk score in real time by analyzing the digital wallet user's risk score and verified personal information, and the risk score of the selected beneficiary, the starting and ending locations of the transaction, the time and date of the transaction, checking the country of birth of the digital wallet user and if the digital wallet user and the selected beneficiary are on a restricted list, a person in public life list, the meta-data, the background check factor, and the countries listed in the primary addresses of both the digital wallet user and the selected beneficiary, whereby the country's rating scores are checked, as well as to see if they are on any type of restricted list, and the method and format in which the funds and items of value are to be received; and
permitting any authorized payout center to bid on and fulfill a money services request by the digital wallet user based on the transaction risk score and an optimization of the request by the digital wallet user and the selected beneficiary, and the locations of the selected beneficiary and the digital wallet user, provided that the locations of the selected beneficiary and the digital wallet user are not considered as a risk by the internet based money and value transfer service server, and have the required verified personal information of the digital wallet user and the selected beneficiary automatically sent to the payout center by the internet based money and value transfer service server, and once the transaction is fulfilled allow the payout center to automatically provide the internet based money and value transfer service server with the transaction details which may be forwarded onto the digital wallet user and the selected beneficiary.

2. The method of claim 1, further comprising: providing at least one of of a regulator, a banking partner, and a permitted third party a view access to the internet based money and value transfer service system, wherein the meta-data may be gathered through public and private sources.

3. The method of claim 1, further comprising: providing any one of the regulator, the banking partner, and the permitted third party reporting access to the internet based money and value transfer service system.

4. The method of claim 1, further comprising: requiring pre-enrollment of digital wallet users' beneficiaries at an authorized center where their personal and biometric details will be captured prior to permitting use of the internet based money and value transfer service system to make transfers to the beneficiaries.

5. The method of claim 4, further comprising:
provisioning an account when a customer care agent of the authorized center creates the account for the digital wallet user including pre-enrolling the user's beneficiaries.

6. The method of claim 5, further comprising:
assessing employees of the authorized centers and the digital wallet users for risk, and based on the assessment automatically generate their risk scores including the user risk score and keep the same updated in real-time based on any changes in the data in which the assessment was based;
determining if at least one of the employees of the authorized centers and the digital wallet users are on a restricted list or person in public life list, and if the countries listed in the primary addresses of the employees of the authorized centers and the digital wallet users and their beneficiaries are considered a risk by a rating organization, and/or are on any type of restricted list;
verifying at least one of the employees of the authorized centers and the digital wallet users through the provided verified personal information including multiple Government ID's, proof of the primary addresses, and biometric information;
verifying the primary addresses of at least one of the employees of the authorized centers and the digital wallet users using the processor and the memory;
capturing and validating the biometric information of at least one of the employees of the authorized centers and the digital wallet users, wherein the biometric information is at least one of a fingerprint, a voice print, and an iris scan; and
verifying the countries of birth of the employees of the authorized centers, the digital wallet users, and their pre-approved beneficiaries may be verified and accessed for risk, using the processor and the memory.

7. The method of claim 1:
wherein the transaction risk score is based on the digital wallet user's risk score and verified personal information, and the risk score of the selected beneficiary, the starting and ending locations of the transaction, the time and date of the transaction, checking the country of birth of the digital wallet user and if the digital wallet user and the selected beneficiary are on restricted list or a person in public life list, the meta-data, the background check factor, and the countries listed in the primary addresses of both the digital wallet user and the selected beneficiary, whereby the country's rating scores are checked, as well as to see if they are on any type of restricted list, and the method and format in which the funds and items of value are to be received; and wherein the user risk score is calculated based on at least one of the user's verified personal information, the user's biometric information, the user's social media profile the risk scores of the user's beneficiaries, the country of birth of the user, whether the user is on the restricted list or person in public life list, the meta-data, the background check factor, and the country listed in the primary address of the user, whereby the country's ratingscore is checked, as well as to see if it is on any type of restricted list.

8. The method of claim 7, wherein the internet based money and value transfer service system is accessible from an internet based device with an active data connection over an Internet Protocol (IP) based network infrastructure.

9. The method of claim 8, further comprising:
sending a short message to at least one of the digital wallet user and the selected beneficiary confirming the transaction, the message including at least one of the time and the location of the transaction, the transaction amount, the digital wallet user's account balance, and a set of details of the receipt of funds of the transaction.

10. The method of claim 9 further comprising:
adjusting the risk score of the digital wallet user if the digital wallet user provides additional verified personal information; and
providing an option to allow the digital wallet user to select from a list of authorized Payout Centers to complete the transaction request and to conduct a direct wallet-to-wallet transaction.

11. A method of an internet based money and value transfer service server, comprising:
associating a digital wallet user with the user's verified personal information and a user's biometric information, using a processor and a memory;
limiting a requested financial transaction amount by at least one of the digital wallet user per a period, a transaction risk score, the digital wallet user's risk score, and a risk score of a selected beneficiary of a transaction and the rating scores of the countries in the primary addresses of the selected beneficiary and the digital wallet user;
constraining a number of Active Beneficiaries by the digital wallet user per the risk score of the digital wallet user;
limiting a wallet balance of the digital wallet user per the period and the digital wallet user's risk score;
constraining the withdrawal amount per the period, based at least in part on the transaction risk score and the digital wallet user's risk score;
automatically determining a user risk score in real time by analyzing at least one of the verified personal information, the user's biometric information, a user's social media profile the risk scores of the user's beneficiaries, the country of birth of the user, whether the user is on a restricted list or a person in public life list, a meta-data, a background check factor, and the country listed in the primary address of the user, whereby a country's rating is checked, as well as to see if it is on any type of restricted list;
automatically determining the transaction risk score in real time by analyzing the digital wallet user's risk score and verfieid personal information, and the risk score of the selected beneficiary, a starting and ending locations of the transaction, the time and date of the transaction, checking the country of birth of the digital wallet user and if the digital wallet user and the selected beneficiary are on the restricted list or a person in public life list, the meta-data, the background check factor, and the countries listed in the primary addresses of both the digital wallet user and the selected beneficiary, whereby the country's rating scores are checked, as well as to see if they are on any type of restricted list, and the method and format in which the funds and items of value are to be received;
permitting any authorized Payout Center to bid on and fulfill a money services request by the digital wallet user based on the transaction risk score and an optimization of the request by the digital wallet user and the selected beneficiary, and the locations of the selected beneficiary and the digital wallet user, provided that the locations of the selected beneficiary and the digital wallet user are not considered as a risk by the internet based money and value transfer service server, and have the required verified personal information of the digital wallet user and the selected beneficiary automatically sent to the payout center by the internet based money and value transfer service server, and once the transaction is fulfilled allow the payout center to automatically provide the internet based money and value transfer service server with the transaction details which may be forwarded onto the digital wallet user and the selected beneficiary;
assessing employees of an authorized centers and the digital wallet users for risk, and based on an assessment automatically generate their user risk score and keep the same updated in real-time based on any changes in the data in which the assessment was based;
determining if at least one of the employees of the authorized centers and the digital wallet users are on a restricted list or person in public life list, and if the countries listed in the primary addresses of the employees of the authorized centers and the digital wallet users and their beneficiaries are considered a risk by a risk rating organization or are on any type of restricted list;
verifying at least one of the employees of the authorized centers and the digital wallet users through the provided verified personal information including multiple Government ID's, proof of the provided primary addresses, and the biometric information;
verifying the primary addresses of the employees of the authorized centers and the digital wallet users using the processor and the memory;
capturing and validating the biometric information of at least one of the employees of the authorized centers and the digital wallet users, wherein the biometric information is at least one of a fingerprint, a voice print, and an iris scan; and
verifying the countries of birth of the employees of the authorized centers, the digital wallet users, and their pre-approved beneficiaries may be verified and accessed for risk, using the processor and the memory.

12. The method of claim 11, further comprising: providing a view access to at least one of a regulator, a banking partner, and a permitted third party to the internet based money and value transfer service system, wherein the meta-data may be gathered through public and private sources.

13. The method of claim 11, further comprising: providing reporting access to at least one of the regulator, the banking partner, and the permitted third party to the internet based money and value transfer service system.

14. The method of claim 11, further comprising: pre-enrolling digital wallet users' beneficiaries at an authorized center where their personal and biometric details will be captured prior to permitting use of the internet based money and value transfer service system to make transfers to the beneficiaries may be required.

15. The method of claim 14 further comprising:
provisioning an account when a customer care agent of the authorized center creates the account for the digital wallet user including pre-enrolling the user's beneficiaries.

16. A method of an internet based money and value transfer service server, comprising:
associating a digital wallet user with the user's verified personal information and a user's biometric information, using a processor and a memory;
limiting a requested financial transaction amount by at least one of the digital wallet user per a period, a transaction risk score, the digital wallet user's risk score, and the risk score of a selected beneficiary of the transaction, and the rating scores of the countries in the primary addresses of the selected beneficiary and the digital wallet user;
constraining a number of Active Beneficiaries by the digital wallet user is limited per the risk score of the digital wallet user;
limiting a wallet balance of the digital wallet user per the period and the digital wallet user's risk score;
constraining the withdrawal amount per the period, the transaction risk score and the digital wallet user's risk score;
automatically determining a user risk score in real time by analyzing at least one of the user's verified personal information, the user's biometric information, a user's social media profile, the risk scores of the user's beneficiaries, the country of birth of the user, whether the user is on a restricted list or person in public life list, a meta-data, a background check factor, and the country listed in the primary address of the user, whereby the country's rating scores is checked, as well as to see if it is on any type of restricted list;
automatically determining the transaction risk score in real time by analyzing the digital wallet user's risk score and verified personal information, and the risk score of the selected beneficiary, a starting and ending locations of the transaction, the time and date of the transaction, checking the country of birth of the digital wallet user and if the digital wallet user and the selected beneficiary are on a restricted list or person in public life list, the meta-data, the background check factor, and the countries listed in the primary addresses of both the digital wallet user and the selected beneficiary, whereby the country's rating scores are checked, as well as to see if they are on any type of restricted list, and the method and format in which the funds and items of value are to be received; and
permitting any authorized Payout Center to bid on and fulfill a money services request by the digital wallet user based on the transaction risk score and an optimization of the request by the digital wallet user and the selected beneficiary, and the locations of the selected beneficiary and the digital wallet user, provided that the locations of the selected beneficiary and the digital wallet user are not considered as a risk by the internet based money and value transfer service server, and have the required verified personal information of the digital wallet user and the selected beneficiary automatically sent to the payout center by the internet based money and value transfer service server, and once the transaction is fulfilled allow the payout center to automatically provide the internet based money and value transfer service server with the transaction details which may be forwarded onto the digital wallet user and the selected beneficiary
wherein the user risk score is based on user's verified personal information, the user's biometric information is at least one of a fingerprint, a voice print, and an iris scan, the user's social media profile, the risk scores of user's beneficiaries, the country of birth of the user, whether the user is on a restricted list or person in public life list, the meta-data, the background check factor, and the country listed in the primary address of the user, whereby the country's rating score is checked, as well as to see if it is on any type of restricted list.
wherein the transaction risk score is based on the digital wallet user's risk score and verified personal information, and the risk score of the selected beneficiary, the starting and ending locations of the transaction, the time and date of the transaction, checking the country of birth of the digital wallet user and if the digital wallet user and the selected beneficiary are on a restricted list or person in public life list, the meta-data, and the background check factor, and the countries listed in the primary addresses of both the digital wallet user and the selected beneficiary, whereby the country's rating scores are checked, as well as to see if they are on any type of restricted list, and the method and format in which the funds and items of value are to be received.

17. The method of claim 16, wherein any one of a regulator a banking partner, and a permitted third party may be provided a view access to the internet based money and value transfer service system, wherein the meta-data may be gathered through public and private sources which may be at least one of a government directory, a user provided verified personal information, the social media profile, and a customer database.

18. The method of claim 16, wherein any one of the regulator, the banking partner, and the permitted third party is provided reporting access to the internet based money and value transfer service system.

19. The method of claim 16, wherein all digital wallet users may be required to sign up including pre-enrolling their beneficiaries at an authorized center where their personal and the biometric details will be captured prior to being permitted to use the internet based money and value transfer service system.

20. The method of claim 19, further comprising:
provisioning an account when a customer care agent of the authorized center creates the account for the digital wallet user including pre-enrolling the user's beneficiaries.
